(19) United States
(12) Patent Application Publication
(10) Pub. No.: US 2024/0010015 A1
(43) Pub. Date: Jan. 11, 2024

(54) RECORDING APPARATUS

(71) Applicant: CANON KABUSHIKI KAISHA, Tokyo (JP)

(72) Inventors: RAN KUDO, Tokyo (JP); SEIJI SUZUKI, Kanagawa (JP); TAKAYA SATO, Tokyo (JP); RYOSUKE ARAKI, Kanagawa (JP); TAKUYA HANE, Kanagawa (JP); TAKAYUKI OKAMOTO, Kanagawa (JP); SATOSHI KIMURA, Kanagawa (JP); SHINGO OKUSHIMA, Kanagawa (JP)

(21) Appl. No.: 18/345,475

(22) Filed: Jun. 30, 2023

(30) Foreign Application Priority Data
Jul. 7, 2022 (JP) 2022-109914
Aug. 1, 2022 (JP) 2022-122717

(51) Int. Cl. B41J 25/00

(52) U.S. Cl. CPC B41J 25/001

(57) ABSTRACT

A recording apparatus includes a conveyance roller configured to convey a recording medium in a conveyance direction, and a moving portion configured to move a recording head between a positioning position and a non-positioning position, the moving portion having a first supporting portion that supports the recording head at the non-positioning position. The first supporting portion does not support the recording head at the positioning position.

### BACKGROUND OF THE INVENTION

### Field of the Invention

The present invention relates to a recording apparatus that discharges ink to a recording material and performs recording.

### Description of the Related Art

There conventionally is known a recording apparatus that records text, images, and so forth by discharging droplets of a recording liquid, such as ink or the like, onto a recording material such as recording paper, resin sheets, or the like. In a case of performing maintenance by capping of a recording head or the like after recording operations in such a recording apparatus, there is a need to perform highly precise positioning of a maintenance portion and the recording head, in order to seal discharge orifices in a sure manner. Japanese Patent Application Publication No. H06-336019 discloses technology in which a capping unit is provided with a mechanism for equalizing with regard to the recording head. Specifically, when the capping unit moves from a non-capping position to a capping position, the equalizing mechanism of the capping unit is restricted, and in a capping state, the restriction of the equalizing mechanism is disengaged.

### SUMMARY OF THE INVENTION

Now, positioning of the recording head is not only for positioning as to the maintenance portion, and the recording head and a conveying portion for conveying the recording material need to be positioned with even higher precision, in order to record high-resolution text and images on the recording material with high precision. The technology disclosed in Japanese Patent Application Publication No. H06-336019 is configured such that a configuration that is the object of positioning follows the recording head. It is difficult to providing an equalizing mechanism that moves the conveying portion itself in the position of the recording head and the conveying portion, since the conveying portion performs conveyance of the recording material and could affect conveyance capabilities and state of conveyance. Further, the center of rotation remains restricted in the equalizing mechanism disclosed in Japanese Patent Application Publication No. H06-336019, and accordingly there is a limit to following capabilities for the recording head to follow a counter unit, and position with even higher precision is difficult.

Also, in a recording apparatus in which a plurality of the recording heads are arrayed with respect to a conveyance path of the recording material, high positioning precision is required for each of the plurality of recording heads with respect to the recording medium conveyance path. The apparatus described in Japanese Patent No. 6034538 ensures precision of positioning during recording operations in a configuration in which a plurality of recording heads are arrayed in an arc form, and accordingly the plurality of recording heads are fixed in a predetermined placement in advance.

In a recording apparatus such as described above, maintenance such as cleaning around nozzle faces of the recording heads and so forth is necessary, and the configuration of a maintenance apparatus needs to match that of a fixed array of the plurality of recording heads, as well. In a case in which the plurality of recording heads are fixedly placed in an arc form such as in the apparatus according to Japanese Patent No. 6034538, the capping unit of the maintenance apparatus needs to be configured in an arc form corresponding to this array. This increases the placement space necessary for the maintenance apparatus, leading to increase in the size of the apparatus.

It is an object of the present invention to provide technology that enables a recording head to be positioned with high precision.

In order to achieve the above object, a recording apparatus according to the present invention includes:
a conveying roller configured to convey a recording medium in a conveyance direction; and
a moving portion configured to move a recording head between a positioning position and a non-positioning position, the moving portion having a first supporting portion that supports the recording head at the non-positioning position, wherein
the first supporting portion does not support the recording head at the positioning position.

Also, in order to achieve the above object, a recording apparatus according to the present invention includes:
a recording unit including a first recording head and a second recording head; and
a moving portion configured to support the recording unit, and configured to move the recording unit to a first position and a second position, wherein
the first recording head is positioned in a first relative placement with respect to the second recording head in a state in which the recording unit is at the first position, and is positioned in a second relative placement that is different from the first relative placement with respect to the second recording head in a state in which the recording unit is at the second position.

Also, in order to achieve the above object, a recording apparatus according to the present invention includes:
a recording head having a first abutting portion and a second abutting portion;
a moving portion configured to move the recording head between a positioning position and a non-positioning position; and
a positioning portion which the first abutting portion and the second abutting portion abut in a state in which the recording head is at the positioning position, wherein in a case of the recording head moving from the non-positioning position to the positioning position, the second abutting portion abuts the positioning portion, and thereafter the first abutting portion abuts the positioning portion.

According to the present invention, a recording head can be positioned with high precision.

Further features of the present invention will become apparent from the following description of exemplary embodiments with reference to the attached drawings.

### BRIEF DESCRIPTION OF THE DRAWINGS

FIG. 1 is a schematic diagram illustrating an internal configuration of a recording apparatus according to a First Example;

FIG. 2 is a control configuration diagram of the recording apparatus according to the First Example;

FIG. 3 is a perspective view of a sheet conveying portion chassis of a recording portion according to the First Example;

FIG. 4 is a perspective view of a recording head raising/lowering mechanism according to the First Example;

FIGS. 5A to 5D are explanatory diagrams of operations of recording heads according to the First Example;

FIGS. 6A and 6B are diagrams illustrating a retracted position of the recording head according to the First Example;

FIG. 7 is a diagram of the retracted position of the recording head according to the First Example, as viewed from a downstream side in a sheet conveyance direction;

FIGS. 8A to 8C are diagrams illustrating a configuration of the recording head and biasing members according to the First Example;

FIGS. 9A and 9B are diagrams for describing movement of the recording head according to the First Example to a printing position;

FIG. 10 is a diagram illustrating movement of the recording head according to the First Example to the printing position, as viewed from the downstream side in the sheet conveyance direction;

FIGS. 11A and 11B are diagrams illustrating the printing position of the recording head according to the First Example;

FIG. 12 is a diagram illustrating the printing position of the recording head according to the First Example, as viewed from the downstream side in the sheet conveyance direction;

FIGS. 13A and 13B are diagrams for describing retracting operations of the recording head according to the First Example;

FIG. 14 is a diagram illustrating the retracting operations of the recording head according to the First Example, as viewed from the downstream side in the sheet conveyance direction;

FIG. 15 is a diagram for describing the recording head and a maintenance portion according to the First Example;

FIG. 16 is a diagram illustrating a state before attaching the recording head according to the First Example to an apparatus main unit;

FIG. 17 is a diagram illustrating a state of inclination of the recording head according to the First Example;

FIG. 18 is a diagram illustrating the state of inclination of the recording head and electrical connector connection portions according to the First Example;

FIG. 19 is a diagram illustrating a state after attaching the recording head according to the First Example to the apparatus main unit;

FIG. 20 is a perspective view illustrating a recording head supporting configuration according to a Second Example;

FIGS. 21A and 21B are views illustrating details of a recording head supporting portion according to the Second Example;

FIG. 22 is a perspective view of a sheet conveying portion chassis of a recording portion according to a Third Example;

FIG. 23A is a diagram illustrating the sheet conveying portion chassis as viewed from above the apparatus;

FIG. 23B is a diagram illustrating a relation among a sheet, the recording heads, and guide rollers;

FIG. 24 is a perspective view of the recording head raising/lowering mechanism;

FIG. 25 is a perspective view of the recording head;

FIGS. 26A to 26D are explanatory diagrams of positioning operations of the recording heads;

FIG. 27 is a diagram showing a flowchart of positioning operations of recording heads at the time of printing;

FIG. 28 is a diagram showing a flowchart of positioning operations of recording heads at the time of maintenance;

FIG. 29 is a diagram illustrating a configuration in which a plurality of recording heads are positioned at different heights;

FIG. 30 is a diagram illustrating a configuration of the maintenance portion;

FIGS. 31A to 31C are diagrams illustrating a retracted position of a first recording head;

FIGS. 32A to 32C are diagrams illustrating a retracted position of a second recording head;

FIGS. 33A to 33C are diagrams illustrating biasing positions of the biasing members;

FIGS. 34A and 34B are diagrams illustrating a configuration of the recording head and the biasing members;

FIGS. 35A to 35D are diagrams illustrating the first recording head and a sheet;

FIGS. 36A to 36D are diagrams illustrating the second recording head and a sheet;

FIGS. 37A to 37C are diagrams for describing movement of the first recording head;

FIGS. 38A to 38C are diagrams for describing movement of the second recording head;

FIGS. 39A to 39C are diagrams for describing movement of the first recording head;

FIGS. 40A to 40C are diagrams for describing movement of the second recording head;

FIGS. 41A to 41C are diagrams for describing movement of the first recording head;

FIGS. 42A to 42C are diagrams for describing movement of the second recording head;

FIGS. 43A to 43C are diagrams illustrating a printing position of the first recording head;

FIGS. 44A to 44C are diagrams illustrating a printing position of the second recording head; and

FIGS. 45A to 45C are diagrams illustrating a maintenance position of the recording head.

### DESCRIPTION OF THE EMBODIMENTS

Embodiments for carrying out the invention will be exemplarily described below in detail by way of Examples, with reference to the Figures. Note that the dimensions, materials, shapes, relative placements thereof, and so forth, of the components described in the embodiments are to be changed as appropriate in accordance with the configuration of the apparatus to which the invention is to be applied, and various conditions. Also, not all combinations of features described in the embodiments are necessarily indispensable for solving means of the present invention. The components described in the embodiments are only exemplary, and are not intended to limit the scope of the intention to these alone.

### First Example

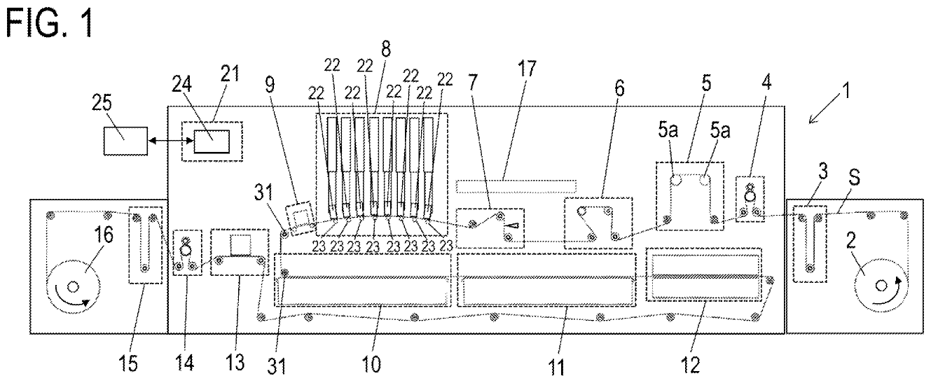

First, upward of an apparatus in FIG. 1 is defined as upward, from the right to the left as a longitudinal direction, and from a near side of the plane of the drawing to a far side orthogonal to a sheet conveyance direction is defined as sheet width direction, and a near side as to the plane of the drawing will be referred to as “apparatus front side”, and the far side as to the plane of the drawing will be referred to as “apparatus rear side”. The recording apparatus 1 according to a First Example is a high-speed line printer that uses a continuous sheet that is wound in the form of a roll.

Recording Apparatus

FIG. 1 is a schematic cross-sectional diagram illustrating an internal configuration of the recording apparatus 1 according to the Present Example. The recording apparatus 1 according to the Present Example includes various types of units therein. That is to say, the recording apparatus 1 includes an unwinding roll portion 2, a first dancer portion 3, a first main conveying portion 4, a skew rectifying portion 5, a conveyance detecting portion 6, a mark sensor portion 7, and a recording portion 8. Further, the recording apparatus 1 includes a first scanner portion 9, a first drying portion 10, a second drying portion 11, a cooling portion 12, a second scanner portion 13, a second main conveying portion 14, a second dancer portion 15, a takeup roll portion 16, and a maintenance portion 17. A sheet S serving as a recording material (recording medium) is conveyed along a sheet conveyance path indicated by a solid line in FIG. 1 by conveying rollers, with processing being performed at each of the units.

The unwinding roll portion 2 is a unit for holding and supplying the continuous sheet that is wound in the form of a roll. The unwinding roll portion 2 is a configuration for storing an unwinding roll and feeding out and supplying the sheet S. Note that the number of rolls that can be stored is not limited to one, and a configuration may be made in which two, or three or more, of the rolls are stored and with one sheet S being selectively fed out and supplied.

The first dancer portion 3 is a unit for imparting a certain amount of sheet tension between the unwinding roll portion 2 and the first main conveying portion 4. The first dancer portion 3 is imparted with sheet tension by a tension imparting unit omitted from illustration. The first main conveying portion 4 is a unit for feeding the sheet S to the skew rectifying portion 5, the conveyance detecting portion 6, the mark sensor portion 7, the recording portion 8, the first scanner portion 9, the first drying portion 10, the second drying portion 11, the cooling portion 12, and the second scanner portion 13, placed along the sheet conveyance path (sheet S) in that order, and for imparting sheet tension between itself and the second main conveying portion 14. The first main conveying portion 4 rotates by a motor that is omitted from illustration being driven, and thereby performs tensioned conveying of the sheet S.

The skew rectifying portion (skew correcting portion) 5 is a unit for performing skew rectifying in the sheet width direction at the time of performing tensioned conveying of the sheet S. The skew rectifying portion 5 is a configuration that includes skew rectifying rollers 5a, and a skew detection sensor that is omitted from illustration, for detecting skew of the sheet S. The skew rectifying rollers 5a are capable of changing inclination thereof as to the sheet S by a motor that is omitted from illustration, and perform skew rectifying of the sheet S on the basis of measurement by the skew detection sensor. At this time, the functions of skew rectifying can be improved by the sheet S passing over the skew rectifying rollers 5a.

The conveyance detecting portion 6 is a unit for detecting tension at the time of performing tensioned conveying between the first main conveying portion 4 and the second main conveying portion 14. Also, the conveyance detecting portion 6 is a unit for detecting the speed of the sheet S, in order to control the image formation timing by the recording portion 8.

The mark sensor portion 7 is a unit for detecting marks printed on the sheet S in advance, in order to control the image formation timing by the recording portion 8.

The recording portion 8 includes a plurality of recording heads 22 and serves as a recording unit, and is a sheet processing portion that performs recording processing on the sheet S by discharging ink serving as a recording liquid from the recording heads 22 onto the conveyed sheet S from above, to form images and so forth. The conveyance path of the recording portion 8 is formed by guide rollers 23 that are placed so as to form an arc that is convex upwards, and a certain amount of tension is imparted to the sheet S, thereby securing clearance as to the recording heads 22. With regard to the recording heads 22, the plurality of recording heads 22 are arrayed in the conveyance direction. In the Present Example, a total of eight line-type recording heads, corresponding to a reactant liquid and three spot colors, in addition to ink of the four colors of black (Bk), yellow (Y), magenta (M), and cyan (C), are included. Note that neither the number of colors nor the number of recording heads 22 is limited to eight. Examples of an inkjet system that can be employed include a system using heater elements, a system using piezoelectric elements, a system using electrostatic elements, a system using a microelectromechanical system (MEMS) element, and so forth. Ink of each of the colors is supplied to the recording heads 22 from ink tanks that are omitted from illustration, via respective ink tubes.

The first scanner portion 9 is a unit that reads images formed on the sheet S by the recording portion 8 during printing, and detects positional deviation and concentration of the images, so as to perform correction with regard to the printing.

The first drying portion 10 and the second drying portion 11 are units that reduce the liquid component contained in the ink imparted onto the sheet S by the recording portion 8 so as to increase fixability between the sheet S and the ink. The second drying portion 11 is placed on a downstream side on the sheet conveyance direction from the first drying portion 10. The first drying portion 10 and the second drying portion 11 heat the sheet S that has been recorded upon, and dry the ink imparted thereto. Inside of the first drying portion 10 and the second drying portion 11, hot air is applied to at least the ink-imparted face (recording face) side of the sheet S passing therethrough, so as to dry the ink-imparted face of the sheet S. In addition to a system of applying hot air, a configuration may be made by combination with a system of irradiating the surface of the sheet S with electromagnetic waves (ultraviolet rays, infrared rays, etc.), or a conductive heat transfer system by contact with a heat generator, as a drying system.

Wind-around guide rollers 31 are rollers around which the face on the opposite side from the ink-imparted face of the sheet S is wound around at a certain contact angle, on the downstream side of the recording portion 8 in the conveyance direction, due to the need to isolate the recording portion 8 from the effects of the hot air of the first drying portion 10. In the Present Example, two wind-around guide rollers 31 are placed between the first scanner portion 9 and the first drying portion 10, and the sheet S is folded back substantially in parallel between above and below in the apparatus. The first drying portion 10 is placed downward from the recording portion 8 in the apparatus, and the second drying portion 11 is placed downward in the apparatus from the conveyance detecting portion 6 and the mark sensor portion 7, which are described above.

The cooling portion 12 cools the sheet S that is fixed at the first drying portion 10 and the second drying portion 11, thereby solidifying softened ink, and also suppressing the amount in temperature change of the sheet S in downstream processes in the recording apparatus. Inside of the cooling portion 12, wind of a temperature that is at least lower than the temperature of the sheet S passing through is applied to the ink-imparted face side of the sheet S, thereby cooling the ink-imparted face of the sheet S. Note that the cooling system is not limited to a system of applying wind, and may be configured as a conductive heat transfer system by contact with a heat dissipation member or a combination thereof.

The second scanner portion 13 is a unit that reads test images formed on the sheet S at the recording portion 8 before printing, detects positional deviation and concentration of images, and performs correction regard to main printing.

The second main conveying portion 14 is a unit that performs sheet conveyance while imparting tension to the sheet S along with the first main conveying portion 4, and adjusts the tension of the sheet S. The second main conveying portion 14 has a clutch (omitted from illustration) that rotates by being driven by a motor that is omitted from illustration, and controls torque that is linked to the clutch through driving in accordance with a tension value that is detected by the conveyance detecting portion 6, thereby adjusting the tension of the sheet S. Note that a configuration that controls the speed of the second main conveying portion 14 by the conveyance detecting portion 6 may be added as an additional configuration to adjust the tension of the sheet S. In this case, an arrangement may be made in which both of the two of a torque control method in which a torque value of torque transmitted from the clutch is controlled, and a speed control method in which the roller speed of the second main conveying portion 14 is controlled, are available, such that tension control methods can be switched or used in conjunction, in accordance with the object.

The second dancer portion 15 is a unit for imparting a certain amount of sheet tension between the second main conveying portion 14 and the takeup roll portion 16. The second dancer portion 15 is imparted with sheet tension from a tension imparting unit omitted from illustration.

The takeup roll portion 16 is a unit for taking up the sheet S subjected to recording processing on a winding core. The number of rolls that are capable of performing collection is not limited to one, and a configuration may be made in which two, or three or more, of the winding cores are provided and being selectively switched for collection of the sheet S. Note that depending on contents of working processing following recording, a configuration may be made in which the continuous sheet is cut using a cutter and the cut sheets S are stacked, instead of the configuration of winding onto a winding core.

The maintenance portion 17 is a unit having a mechanism for restoring the discharge performance of the recording heads 22 (maintenance unit). Examples of such a mechanism include, for example, a capping mechanism that protects ink discharge faces of the recording heads 22, a wiper mechanism that performs wiping of the ink discharge faces, and a suctioning mechanism that performs negative pressure suctioning of ink within the recording heads 22 from the ink discharge faces. The maintenance portion 17 also includes a driving mechanism and a rail that are omitted from illustration, and is capable of reciprocal movement in a horizontal direction along the rails. When performing maintenance of the recording heads 22, the maintenance portion 17 moves to directly below the recording heads 22, and when not performing maintenance operations, moves from directly below the recording heads 22 to a retracted position on an upstream side in the conveyance direction.

A control portion 21 is a unit that controls each part of the overall recording apparatus. The control portion 21 includes a central processing unit (CPU), a storage apparatus, a controller that includes various types of control portions, and external interface, and an operating portion 24 for a user to perform input/output. Operations of the recording apparatus 1 are controlled on the basis of commands from a host apparatus 25, such as a controller, a host computer connected to the controller via an external interface, or the like.

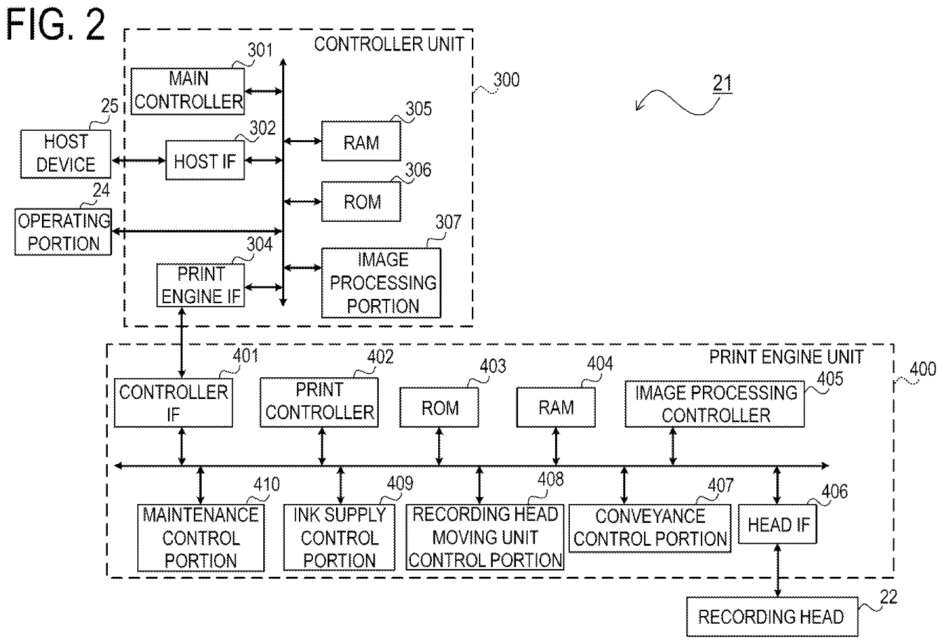

FIG. 2 is a block diagram illustrating a control configuration of the recording apparatus 1. The control configuration of the control portion 21 is primarily made up of a print engine unit 400 that centrally controls the recording apparatus 1, and a controller unit 300 that centrally controls the overall recording apparatus 1. A print controller 402 controls various types of mechanisms of the print engine unit 400, under instructions from a main controller 301 of the controller unit 300. Details of the control configuration will be described below.

In the controller unit 300, the main controller 301 that is made up of a CPU controls the overall recording apparatus 1 following programs and various types of parameters stored in read-only memory (ROM) 306, using random-access memory (RAM) 305 as a work area. For example, upon a print job being input from the host apparatus 25 via host I/F 302, an image processing portion 307 performs predetermined image processing on image data that is received, following instructions from the main controller 301. The main controller 301 then transmits the image data subjected to the image processing to the print engine unit 400 via a print engine I/F 304.

Note that the recording apparatus 1 may acquire image data from the host apparatus 25 via wireless communication or wired communication, or may acquire image data from an external storage apparatus (Universal Serial Bus (USB) memory or the like) connected to the recording apparatus 1. The communication format used for wireless communication or wired communication is not limited. For example, Wireless Fidelity (Wi-Fi, a registered trademark) and Bluetooth (registered trademark) are applicable as communication formats used for wireless communication. Also, Universal Serial Bus (USB) or the like is applicable as a communication format used for wired communication.

The operating portion 24 is a mechanism for the user to perform input/output to and from the recording apparatus 1. The user can set printing modes, recognize information of the recording apparatus 1, and so forth, via the operating portion 24.

In the print engine unit 400, the print controller 402 that is made up of a CPU controls the various types of mechanisms that the recording apparatus 1 has, following programs and various types of parameters stored in ROM 403, using RAM 404 as a work area. Upon various types of commands and image data being received via a controller I/F 401, the print controller 402 temporarily stores these in the RAM 404. The print controller 402 causes an image processing controller 405 to convert the saved image data into recording data, so as to be usable for recording operations by the recording heads 22. Upon the recording data being generated, the print controller 402 causes the recording heads 22 to execute recording operations based on the recording data, via a head I/F 406. At this time, the print controller 402 drives the various types of units illustrated in FIG. 1 via a conveyance control portion 407, so as to convey the sheet S. That is to say, the print controller 402 drives the unwinding roll portion 2, the first dancer portion 3, the first main conveying portion 4, the skew rectifying portion 5, the conveyance detecting portion 6, the mark sensor portion 7, the recording portion 8, the first scanner portion 9, the first drying portion 10, the second drying portion 11, the cooling portion 12, the second scanner portion 13, the second main conveying portion 14, the second dancer portion 15, and the takeup roll portion 16. Recording operations are executed by the recording heads 22 following instructions from the print controller 402, synchronously with conveying operations of the sheet S, thereby performing printing processing.

A recording head moving means control portion 408 changes the positions of the recording heads 22 in accordance with the operating state of the recording apparatus 1, such as maintenance state or recording state. An ink supply control portion 409 controls an ink supply unit (omitted from illustration) such that the pressure of ink supplied to the recording heads 22 is within an appropriate range. A maintenance control portion 410 controls operations of the maintenance portion 17 at the time of performing maintenance operations with regard to the recording heads 22.

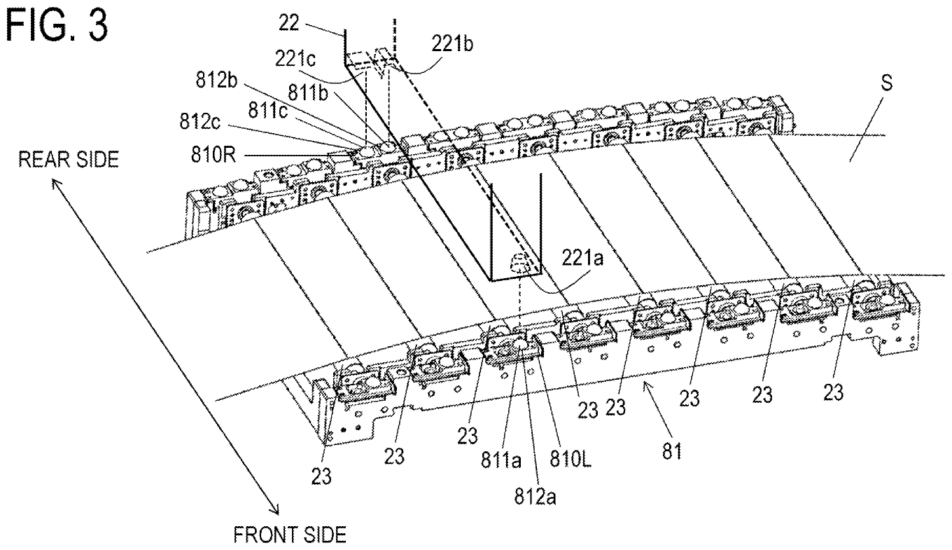

FIG. 3 is a perspective view of a sheet conveying portion chassis 81 serving as a conveyance unit of the recording portion 8. As illustrated in FIG. 3, the sheet conveying portion chassis 81 of the recording portion 8 includes a plurality of each of a first positioning member 811a, a second positioning member 811b, and a third positioning member 811c, for positioning the recording heads 22 at a printing position (recording position). For each recording head 22, there is provided the first positioning member 811a at the near side (apparatus front side) across the sheet S in the sheet width direction orthogonal to the sheet conveyance direction, and the second positioning member 811b and the third positioning member 811c at the far side (apparatus rear side).

The first positioning member 811a, the second positioning member 811b, and the third positioning member 811c are each spherical members of the same diameter as each other. The first positioning member 811a, the second positioning member 811b, and the third positioning member 811c are each attached by being fit into recessed portions 812 provided in positioning supporting portions 810 that the sheet conveying portion chassis 81 has. Substantially downward (lower hemisphere) portions of the first positioning member 811a, the second positioning member 811b, and the third positioning member 811c are each embedded in the recessed portions 812, and substantially upward (upper hemisphere) portions that are exposed from the recessed portions 812 form protruding-form positioning portions that have substantially hemispherical forms protruding upward. The positioning supporting portion 810 includes a near-side positioning supporting portion 810L that is placed on the near side in the sheet width direction with respect to the sheet conveyance path, and a far-side positioning supporting portion 810R that is placed on the far side. The first positioning member 811a is attached to a first recessed portion 812a provided in the near-side positioning supporting portion 810L. The second positioning member 811b is attached to a second recessed portion 812b provided in the far-side positioning supporting portion 810R, and the third positioning member 811c is attached to a third recessed portion 812c provided in the far-side positioning supporting portion 810R. The second recessed portion 812b is provided on the upstream side in the sheet conveyance direction with respect to the third recessed portion 812c.

The first positioning member 811a and the second positioning member 811b are placed such that a straight line passing through the center of the first positioning member 811a and through the center of the second positioning member 811b is parallel to rotational axis lines of the guide rollers 23. Also, the third positioning member 811c is placed on the downstream side from the first positioning member 811a and the second positioning member 811b in the sheet conveyance direction. In a raising/lowering movement direction between the retracted position and the printing position of the recording head 22, the third positioning member 811c is placed at a predetermined height with respect to the first positioning member 811a and the second positioning member 811b. The placement of the third positioning member 811c with respect to the first positioning member 811a and the second positioning member 811b is set such that a nozzle plate (omitted from illustration) of the recording head 22 situated at the printing position can be positioned so as to be parallel to the sheet S supported by a plurality of the guide rollers 23. That is to say, a placement position of the third positioning member 811c is set such that the recording head 22 at the printing position is positioned at a posture inclined by a predetermined angle at a predetermined recording position. The predetermined angle here is an angle in which nozzles (discharge orifices) of the nozzle plate face the recording face of the sheet S perpendicularly (a nozzle face at which the nozzles open (discharge orifice face) is parallel as to the recording face). The first positioning member 811a, the second positioning member 811b, and the third positioning member 811c are each spheres with the same diameter, as described above, and the center of each is the center of the respective sphere.

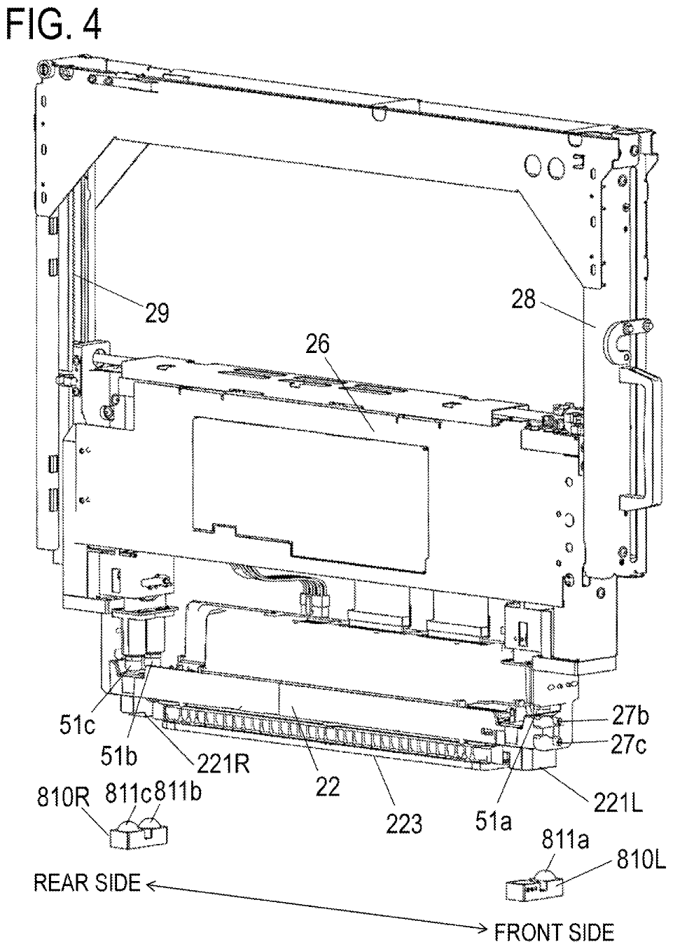

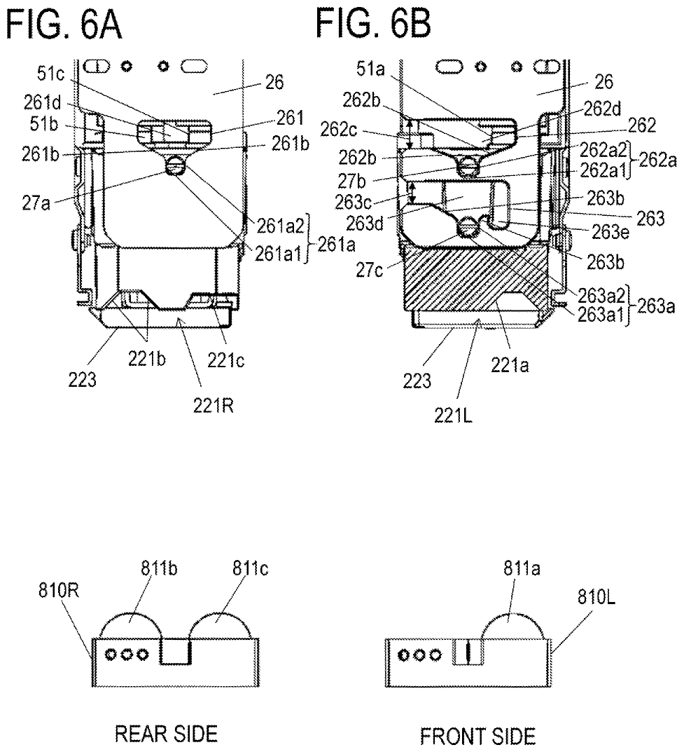

As illustrated in FIG. 4, the recording head 22 is held by a head holder 26 that serves as a moving portion, and is configured to perform raising/lowering movement, up and down, by movement of the head holder 26. The recording head 22 is provided with a first pin 27a (see FIG. 6A, etc.), a second pin 27b, and a third pin 27c, serving as supported portions. The first pin 27a is a protruding portion that, out of both ends of the recording head 22 in the longitudinal direction (width direction) of the recording head 22 that is an intersection direction that intersects each of a raising/lowering direction of the recording head 22 and the sheet conveyance direction, protrudes from one end portion (apparatus rear side) of the recording head 22 in the width direction (intersecting direction). The second pin 27b and the third pin 27c are protruding portions that each protrude in the longitudinal direction from the other end portion (apparatus front side) of the recording head 22 in the longitudinal direction of the recording head 22. The recording head 22 is axially supported with respect to the head holder 26, by the first pin 27a, the second pin 27b, and the third pin 27c being respectively supported from below by a first hole 261, a second hole 262, and a third hole 263 provided in the head holder 26.

Further, the recording head 22 is supported by the head holder 26 in a state of being biased downward by a first biasing member 51a, a second biasing member 51b, and a third biasing member 51c, which are provided on the head holder 26. The configurations of the first biasing member 51a, the second biasing member 51b, and the third biasing member 51c will be described later. The head holder 26 performs raising/lowering operations along rails 29 for raising/lowering that are provided within a recording head raising/lowering frame 28, by an internally-provided driving mechanism that is omitted from illustration.

Operation Example of Recording Head

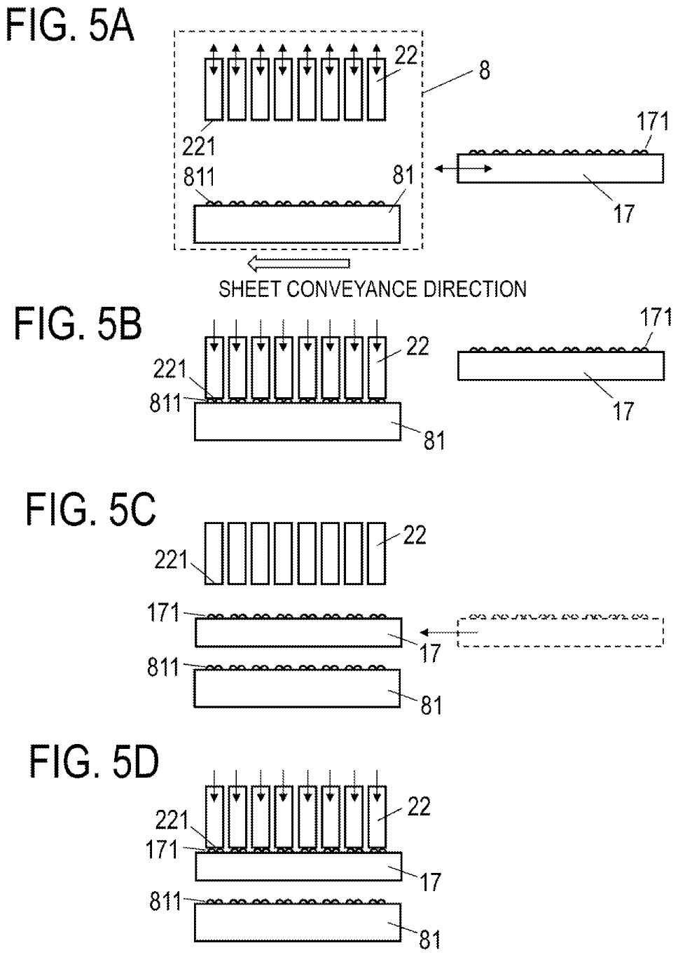

Operations of the recording heads 22 in the recording apparatus according to the Present Example will be briefly described with reference to FIGS. 5A to 5D. FIGS. 5A to 5D are schematic explanatory diagrams illustrating an operation example of the recording heads 22.

FIG. 5A is a schematic diagram illustrating a state in which the recording heads 22 are at the retracted position retracted upward as to the sheet conveying portion chassis 81, as a non-positioning position, and the maintenance portion 17 is in a non-maintenance position retracted substantially horizontally in the longitudinal direction (sheet conveyance direction) from the recording heads 22.

FIG. 5B is a schematic diagram illustrating a state in which the recording heads 22 are at the printing position (recording position) for recording images on the sheet S, as a positioning position. In a case of the recording heads 22 transitioning from the upward retracted position (second position) to the printing position for recording images on the sheet S, the recording heads 22 move substantially vertically downward from the upward retracted position, by the recording head raising/lowering mechanism described above. Movement of the recording heads 22 is completed by positioned portions 221 abutting recording head positioning members 811 that the sheet conveying portion chassis 81 is provided with, and an orientation of the recording heads 22 being a posture inclined at a predetermined angle, and descending to the printing position where positioning is performed. That is to say, as illustrated in FIG. 5B, the printing position (example of first position) is achieved by abutting portions (positioned portions 221) provided on lower portions of the recording heads 22 and a positioning portion (positioning members 811) provided on a conveying portion, which is an example of a counter unit, being positioned.

FIG. 5C is a schematic diagram illustrating a state in which the recording heads 22 are at the retracted position, and the maintenance portion 17 has moved to the maintenance position. Restoring operations of the recording heads 22 by the maintenance portion 17 that is an example of the counter unit may be performed in cases in which capping of the recording heads 22 is to be performed after completing printing, in a case in which the nozzles of the recording heads 22 become clogged and ink discharge defects occur, and so forth. In transition to the maintenance position, first, the state illustrated in FIG. 5A, in which the recording heads 22 and the maintenance portion 17 have moved to their respective retracted positions is realized. Thereafter, the maintenance portion 17 moves to the maintenance position directly below the recording heads 22, as illustrated in FIG. 5C.

FIG. 5D is a schematic diagram illustrating a state in which the recording heads 22 have moved to the maintenance position at which maintenance operations by the maintenance portion 17 are carried out, as the positioning position. The recording heads 22 move substantially vertically downward from the position illustrated in FIG. 5C, and the positioned portions 221 of the recording heads 22 are positioned as to recording head positioning members 171 that the maintenance portion 17 is provided with, as illustrated in FIG. 5D. Accordingly, transmission operations to the maintenance position (example of first position) of the recording heads 22 is completed. Various types of maintenance operations of the recording heads 22 by the maintenance portion 17 are executed in this state.

Positioning as to Supporting Configuration of Recording Head A supporting configuration and operation example of the recording heads 22 according to the Present Example will be described in detail with reference to FIGS. 6A, 6B, 7, 8A to 8C, 9A, 9B, 10, 11A, 11B, 12, 13A, 13B, and 14 to 19.

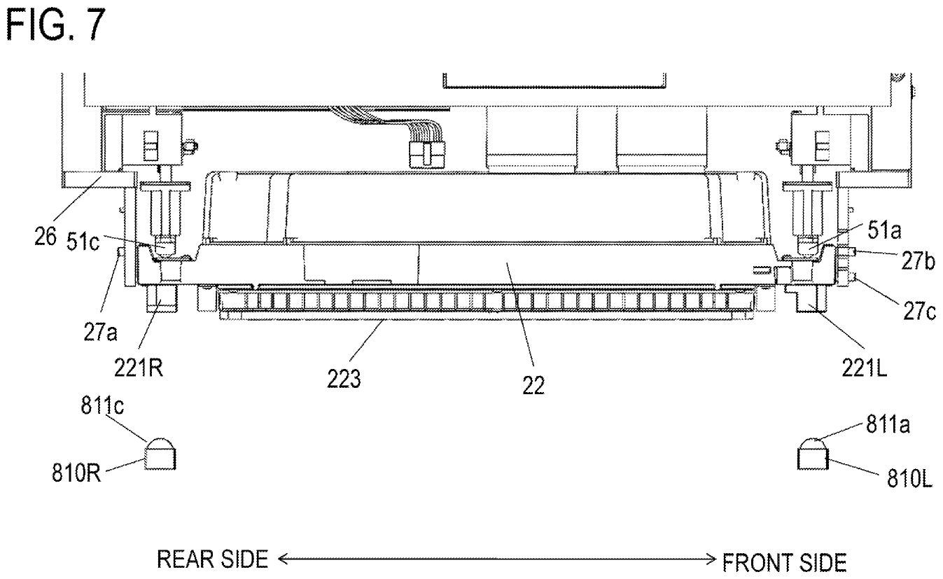

FIGS. 6A, 6B, and 7 illustrate a state at the retracted position where the recording head 22 has retracted upward, in which FIG. 6A is a diagram as viewed from the apparatus rear side, FIG. 6B is a diagram as viewed from the apparatus front side, and FIG. 7 is a diagram as viewed from the downstream side in the sheet conveyance direction.

The recording head 22 has an ink discharge portion 223 in which a plurality of the nozzle plates (omitted from illustration), each having a plurality of the nozzles (discharge orifices) that discharge ink, are placed arrayed in the longitudinal direction of the recording head (sheet width direction). The ink discharge portion 223 is provided so as to face the conveying region of the sheet S. Also, positioned portions 221L and 221R are provided on respective ends of the recording head 22 in the longitudinal direction (direction orthogonal to the sheet conveyance direction). Specifically, the positioned portion 221L on the near side in the head longitudinal direction (apparatus front side) is provided with a first abutting portion 221a that is made of a recessed-form portion having a conical inclined face. Also, the positioned portion 221R on the far side in the head longitudinal direction (apparatus rear side) is provided with a second abutting portion 221b that is made of a groove-form portion that has two flat faces in a substantial letter-V form and that extends in the head longitudinal direction, and a third abutting portion 221c that is made of a planar portion, the second abutting portion 221b and the third abutting portion 221c being arrayed in the sheet conveyance direction.

In the longitudinal direction of the recording head 22, a straight line passing through the center of the first abutting portion 221a and the center of the second abutting portion 221b is placed so as to be in parallel with the array of the plurality of nozzle plates in the ink discharge portion 223 of the recording head 22 with good precision. Now, the centers of the first abutting portion 221a and the second abutting portion 221b are each the centers of hypothetical spheres of the same diameter that are each in contact therewith internally. The third abutting portion 221c is placed at a position away from the second abutting portion 221b in the sheet conveyance direction (direction orthogonal to the longitudinal direction of the recording head 22).

As described above, the recording head 22 is provided with the first pin 27a that is a first protruding portion protruding from one end in the sheet width direction, the second pin 27b that is a second protruding portion protruding from the other end in the sheet width direction, and the third pin 27c that is a third protruding portion. With respect to this, the head holder 26 that supports the recording head 22 is provided with the first hole 261, the second hole 262, and the third hole 263. The first hole 261 is a hole portion that has a face facing as to the first pin 27a in a direction perpendicular to the longitudinal direction of the recording head 22, the second hole 262 as to the second pin 27b, and the third hole 263 as to the third pin 27c, respectively. The first hole 261, the second hole 262, and the third hole 263 are each configured having a broadly opened width as to the pin on the upper side thereof, and a narrow width in a groove form in which the pin fits on the lower side thereof.

The first hole 261 has a first groove portion 261a that is a first supporting portion for supporting the first pin 27a, a first inclined portion 261b for guiding the first pin 27a to the first groove portion 261a, and a first opened portion 261d for broadening a movable range of the first pin 27a with respect to the first hole 261. The first groove portion 261a includes a supporting face 261a1 that is a groove bottom face, and restricting faces 261a2 that are a pair of groove side faces that face the first pin 27a so as to clamp the first pin 27a disposed on the supporting face 261al from both sides thereof. The first inclined portion 261b is continuous from the first groove portion 261a, and is a guide portion for guiding the first pin 27a into the first groove portion 261a. The first inclined portion 261b has a pair of inclined faces (guide faces) inclined such that an opposing width thereof in the direction (second intersecting direction) intersecting each of an advancing/retracting direction of the head holder 26 and the width direction of the recording head 22 (sheet width direction) gradually narrows toward the restricting faces 261a2.

The second hole 262 has a second groove portion 262a that is a second supporting portion for supporting the second pin 27b, a second inclined portion 262b for guiding the second pin 27b to the second groove portion 262a, and a second opened portion 262d for broadening a movable range of the second pin 27b with respect to the second hole 262. The second groove portion 262a includes a supporting face 262al that is a groove bottom face, and restricting faces 262a2 that are a pair of groove side faces that face the second pin 27b so as to clamp the second pin 27b disposed on the supporting face 262al from both sides. The second inclined portion 262b is continuous from the second groove portion 262a, and is a guide portion for guiding the second pin 27b into the second groove portion 262a. The second inclined portion 262b has a pair of inclined faces (guide faces) inclined such that the opposing width thereof in the direction intersecting each of the advancing/retracting direction of the head holder 26 and the width direction of the recording head 22 (sheet width direction) gradually narrows toward the restricting faces 262a2. The second hole 262 further has a second notch portion 262c for guiding the second pin 27b so as to be insertable into the second hole 262.

The third hole 263 has a third groove portion 263a for supporting the third pin 27c, a third inclined portion 263b for guiding the third pin 27c to the third groove portion 263a, and a third opened portion 263d for broadening a movable range of the third pin 27c with respect to the third hole 263. The third groove portion 263a includes a supporting face 263al that is a groove bottom face, and restricting faces 263a2 that are a pair of groove side faces that face the third pin 27c so as to clamp the third pin 27c disposed on the supporting face 263al from both sides. The third inclined portion 263b is continuous from the third groove portion 263a, and is a guide portion for guiding the third pin 27c into the third groove portion 263a. The third inclined portion 263b has a pair of inclined faces (guide faces) inclined such that the opposing width thereof in the direction intersecting each of the advancing/retracting direction of the head holder 26 and the width direction of the recording head 22 (sheet width direction) gradually narrows toward the restricting faces 263a2. The third hole 263 further has a third notch portion 263c for guiding the third pin 27c so as to be insertable into the third hole 263, and a fourth groove portion 263e that is used at the time of replacing the recording head.

In the configuration for assembling the recording head 22 to the head holder 26, the first hole 261 is a closed hole, while the second hole 262 and the third hole 263 are holes that are opened to the side at the opened portions 262d and 263d. That is to say, the second notch portion 262c is provided to the second hole 262, and the second hole 262 is opened in the direction orthogonal to the longitudinal direction of the recording head 22, such that the second pin 27b can be introduced into the second hole 262 from this direction. In the same way, the third notch portion 263c is provided to the third hole 263, and the third hole 263 is opened in the direction orthogonal to the longitudinal direction of the recording head 22, such that the third pin 27c can be introduced into the third hole 263 from this direction.

The fourth groove portion 263e provided in the third hole 263 is an engaging groove portion which the third pin 27c is capable of engaging, and is used to hold the recording head 22 at an inclined posture, in order to facilitate work of electrical connection between the recording head 22 and the recording apparatus 1 when replacing the recording head 22. Note that this engaging groove portion may be provided in the second hole 262 instead of in the third hole 263, or alternatively in both of the third hole 263 and the second hole 262.

Also, the first biasing member 51a, the second biasing member 51b (placed at the position illustrated in FIG. 4, and omitted from illustration in FIG. 7 due to overlapping thereof with the third biasing member 51c), and the third biasing member 51c, which include compression springs that are omitted from illustration, are provided to the head holder 26.

The first biasing member 51a is placed so as to impart the recording head 22 with biasing force at a side thereof nearer to the first abutting portion 221a or the second abutting portion 221b than the third abutting portion 221c, in the direction orthogonal to the raising/lowering direction (advancing/retracting direction) of the recording head 22 or the sheet conveyance direction. Preferably, the first biasing member 51a is placed upward of the first abutting portion 221a, i.e., at a portion that overlaps at least part of the first abutting portion 221a when viewed in the raising/lowering direction of the recording head 22. The second biasing member 51b is placed so as to impart the recording head 22 with biasing force at a side thereof nearer to the first abutting portion 221a or the second abutting portion 221b than the third abutting portion 221c, in the direction orthogonal to the raising/lowering direction (advancing/retracting direction) of the recording head 22 or the sheet conveyance direction. Preferably, the second biasing member 51b is placed upward of the second abutting portion 221b, i.e., at a portion that overlaps at least part of the second abutting portion 221b when viewed in the raising/lowering direction of the recording head 22. The third biasing member 51c is placed so as to impart the recording head 22 with biasing force at a side thereof nearer to the third abutting portion 221c than the first abutting portion 221a or the second abutting portion 221b, in the direction orthogonal to the raising/lowering direction (advancing/retracting direction) of the recording head 22 or the sheet conveyance direction. Preferably, the third biasing member 51c is placed upward of the third abutting portion 221c, i.e., at a portion that overlaps at least part of the third abutting portion 221c when viewed in the raising/lowering direction of the recording head 22.

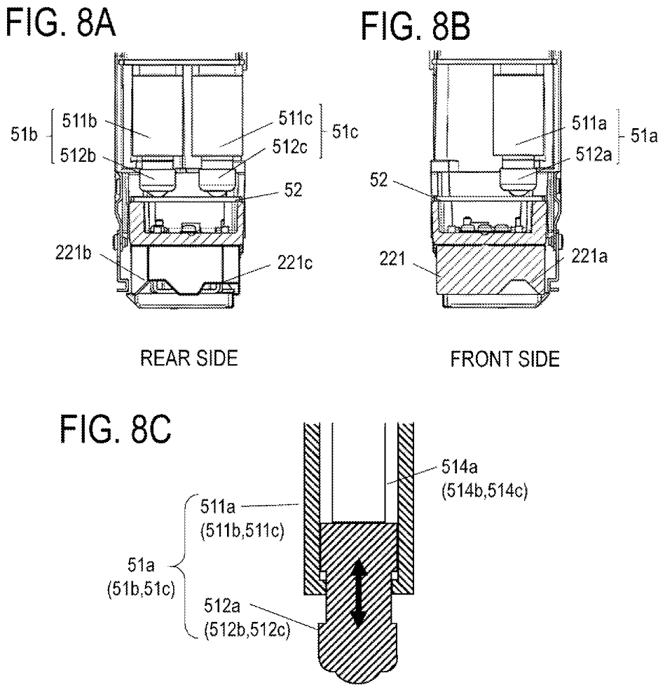

As illustrated in FIGS. 8A to 8C, the first biasing members 51a, 51b, and 51c are respectively made up of a base portion 511a, 511b, and 511c, a sliding portion 512a, 512b, and 512c, and a compression spring 514a, 514b, and 514c. The sliding portions 512a, 512b, and 512c are configured to be capable of advancing/retracting movement in a direction of biasing the recording head 22, with respect to the base portions 511a, 511b, and 511c.

As illustrated in FIG. 8C, the base portion 511 (511a, 511b, 511c) is a substantially cylindrical member, into which a sliding portion 512 (sliding portions 512a, 512b, and 512c) is partially inserted. The sliding portion 512 is configured such that a distal end portion of a side thereof that is exposed from the base portion 511 abuts a plate 52 provided on the recording head 22, and a basal end portion on a side inserted into an insertion hole portion of the base portion 511 receives biasing force from the compression spring 514 (514a, 514b, 514c). The compression spring 514 is assembled to a portion within the insertion hole portion of the base portion 511 that is deeper than where the sliding portion 512 is situated, and presses the basal end of the sliding portion 512 so as to move the sliding portion 512 from the deep side of the insertion hole toward an exit side in the raising/lowering direction of the recording head 22. An engaged portion that protrudes in a direction intersecting the insertion direction is provided on the sliding portion 512 at a part thereof that is inserted into the insertion hole of the base portion 511, and an inward-facing flange portion for preventing the sliding portion 512 from falling out is provided at an opening portion of the insertion hole of the base portion 511. Abutting engagement of the engaged portion and the flange portion with each other defines the movable range of the sliding portion 512 as to the base portion 511 in the direction of biasing the recording head 22.

The distal end portion of the sliding portion 512 is configured as a protruding portion, in which the portion that abuts the plate 52 has a protruding partial spherical face. The angle of the plate 52 that the distal end portion of the sliding portion 512 abuts changes with respect to the advancing/retracting direction of the sliding portion 512, as the posture of the recording head 22 changes. According to the above-described protruding-form configuration, when the angle of the plate 52 changes, the sliding portion 512 can change the position of contact by sliding on the plate 52 while performing advancing/retracting movement with respect to the base portion 511, and thereby maintain the state of biasing the recording head 22. Note that the shape of the distal end of the sliding portion 512 is not limited to a protruding partial spherical face such as described above, and other shape configurations may be used as appropriate, as long as a configuration in which sliding can be performed while maintaining the biasing state.

As illustrated in FIGS. 6A, 6B, and 7, the first pin 27a, the second pin 27b, and the third pin 27c of the recording head 22 in the retracted position are respectively supported by the first groove portion 261a, the second groove portion 262a, and the third groove portion 263a of the head holder 26. Further, the recording head 22 is supported in a state biased against the head holder 26 by the biasing force of the first biasing member 51a, the second biasing member 51b (placed at the position illustrated in FIG. 4, and omitted from illustration in FIG. 7 due to overlapping thereof with the third biasing member 51c), and the third biasing member 51c. The pins 27a to 27c are in a state of being pressed against the supporting faces 261al to 263al that are groove bottom faces of the groove portions 261a to 263a under the biasing force of the biasing members 51a, 51b, and 51c. Also, the pairs of restricting faces 261a2 to 263a2 face each other in a direction intersecting the advancing/retracting direction of the recording head 22 so as to be capable of abutting the pins 27a to 27c pressed against the supporting faces 261al to 263al, and thus restrict movement of the pins 27a to 27c in this intersecting direction. Further, an engaging portion of the second pin 27b and the second groove portion 262a, and an engaging portion of the third pin 27c and the third groove portion 263a are placed at positions offset in the advancing/retracting direction of the recording head 22. Accordingly, the recording head 22 is in a state of being supported by the head holder 26 in a first supporting mode, in which change in the angle that changes the orientation of the discharge face, i.e., relative rotation as to the head holder 26 about the rotational axis line (axis) in the sheet width direction (width direction of the recording head 22) that is the intersecting direction that intersects the sheet conveyance direction, is restricted.

However, the present invention is not limited to a configuration such as described above for imparting biasing force, and in a case in which the weight of the recording head 22 is sufficiently great, the biasing force of the first biasing member 51a, the second biasing member 51b, and the third biasing member 51c can be omitted. Also, although an arrangement has been made in the Present Example in which the diameter of the first pin 27a is 5.90 to 6.00 mm, and the width of the first groove portion 261a is 6.00 to 6.10 mm, these are not limiting, and it is sufficient as long as the dimensional difference between the diameter of the pin and the width of the groove is around 1 mm. This holds true for the second pin 27b and the second groove portion 262a, and the third pin 27c and the third groove portion 263a, as well.

By the first groove portion 261a, the second groove portion 262a, and the third groove portion 263a provided to the head holder 26 supporting the first pin 27a, the second pin 27b, and the third pin 27c provided on the recording head 22, two of the three pins serve as a reference, and the remaining one serves as a rotation stopper. That is to say, in relation to the present invention, the first pin 27a is a first supported portion, and the first groove portion 261a is a first supporting portion that supports one end of the recording head 22 in the intersecting direction that intersects the sheet conveyance direction. Also, one pin of the second pin 27b and the third pin 27c is a second supported portion, and at the same time is a rotation-restricted portion in relation as to the other pin. In accordance with this, one groove portion of the second groove portion 262a and the third groove portion 263a is a second supporting portion that supports the other end of the recording head 22 in the intersecting direction that intersects the sheet conveyance direction, and at the same time is a rotation restricting portion in relation as to the other groove portion. Also, a pair of the groove side faces of this groove portion are rotation restricting faces, i.e., abutting faces that are capable of abutting the second pin 27b and the third pin 27c in the above-described second intersecting direction. In the same way, the other pin of the second pin 27b and the third pin 27c is a second supporting portion, and at the same time is a rotation-restricted portion in relation as to the one pin. In accordance with this, the other groove portion of the second groove portion 262a and the third groove portion 263a is a second supporting portion, and at the same time is a rotation restricting portion in relation as to the one groove portion. Also, the pair of groove side faces of this groove portion are rotation restricting faces. Accordingly, the recording head 22 in the retracted position is supported by the head holder 26 in a stable posture. Also, in the Present Example, the first pin 27a and the second pin 27b are provided at substantially the same height, but may be provided at different heights.

Also, a configuration is described in the Present Example in which the three pins are each supported portions, and the three grooves are each supporting portions, but a configuration may be made in which, for example, just one of the second pin 27b and the third pin 27c is a supported portion, and the other functions only as a rotation-restricted portion. That is to say, a configuration may be made in which the other pin of the second pin 27b and the third pin 27c does not come into contact with the groove bottom face of the groove portion into which it is fit, and in this case, this groove portion only functions as a rotation restricting portion, and the pair of groove side faces of this groove portion function as rotation restricting faces. The recording head 22 can be supported in a stable posture with such a configuration as well, in the same way as in the Present Example, and highly precise positioning can be performed as to the counter unit, which will be described later.

Also, depending on variance in manufacturing precision regarding the installation position of the second pin 27b and the third pin 27c, or the second groove portion 262a and the third groove portion 263a, for example, a configuration can result in which one pin of the second pin 27b and the third pin 27c cannot sufficiently come into contact with the groove bottom face of the groove portion. Even in such a case, the recording head 22 can be supported in a stable posture, in the same way as in the Present Example, and highly precise positioning can be performed as to the counter unit.

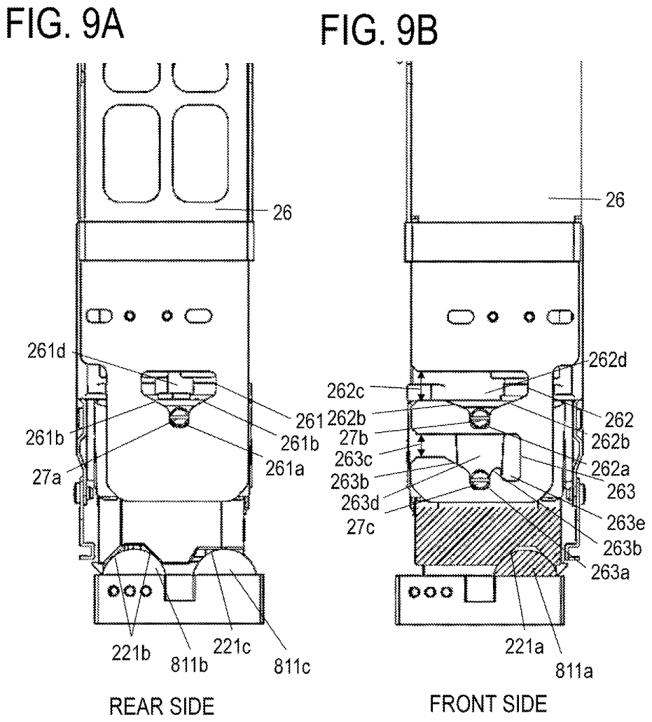

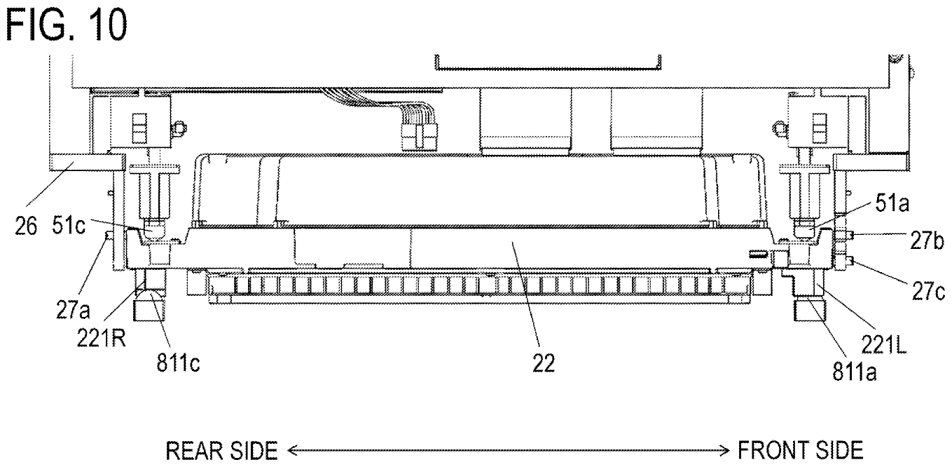

FIGS. 9A, 9B, and 10 are diagrams illustrating the head holder 26 supporting the recording head 22 that has descended from the retracted position toward the printing position, with the first abutting portion 221a, the second abutting portion 221b, and the third abutting portion 221c of the recording head 22 abutting the positioning members 811 of the conveying portion. FIG. 9A is a diagram as viewed from the apparatus rear side, FIG. 9B is a diagram as viewed from the apparatus front side, and FIG. 10 is a diagram as viewed from the downstream side in the sheet conveyance direction. At this time, the first abutting portion 221a, the second abutting portion 221b, and the third abutting portion 221c of the recording head 22 are abutting the positioning members 811, and accordingly, even if the head holder 26 descends further, the recording head 22 will not descend.

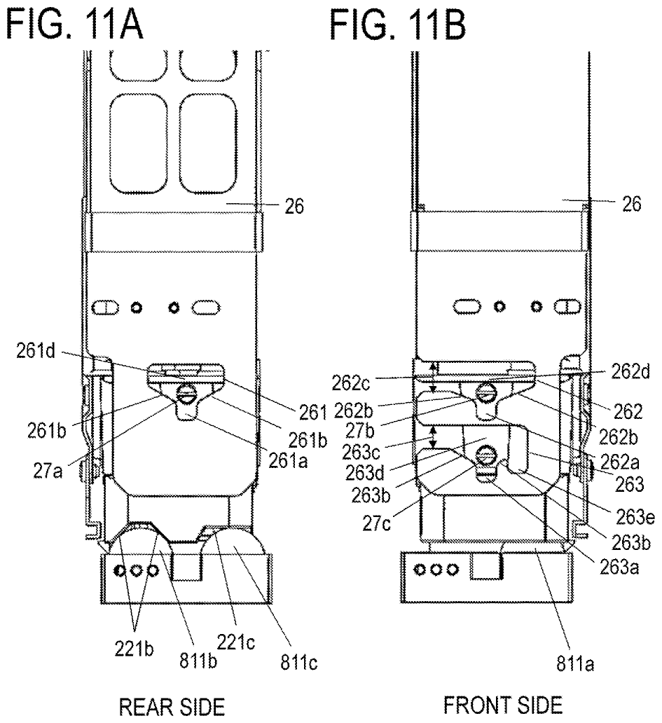

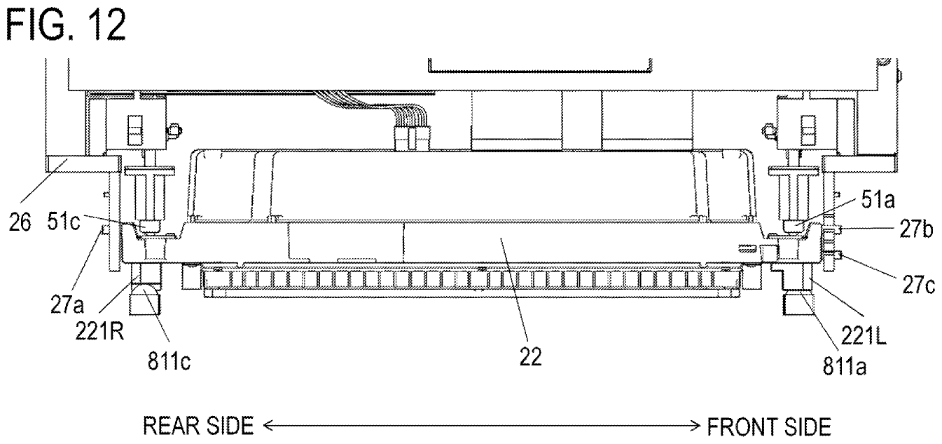

Next, FIGS. 11A, 11B, and 12 are diagrams illustrating a state in which the head holder 26 further descends, and positioning of the recording head 22 and the conveying portion is complete (printing position). FIG. 11A is a diagram as viewed from the apparatus rear side, FIG. 11B is a diagram as viewed from the apparatus front side, and FIG. 12 is a diagram as viewed from the downstream side in the sheet conveyance direction. Due to the head holder 26 descending further from the abutting state in FIGS. 9A, 9B, and 10, the first to third abutting portions 221a to 221c of the recording head 22 are biased against the positioning members 811 by the first to third biasing members 51a to 51c provided to the head holder 26, and the recording head 22 is positioned. Note that the second biasing member 51b is placed at the position illustrated in FIG. 4, and omitted from illustration in FIG. 12 due to overlapping thereof with the third biasing member 51c. At this time, the first to third pins 27a to 27c are separated from the supporting faces 261al to 263al, disengaged from the opposing regions of the pairs of restricting faces 261a2 to 263a2, and are released from the first to third groove portions 261a to 263a to be in a state of not being in contact with the first to third groove portions 261a to 263a. At the same time, the first to third abutting portions 221a to 221c are in a state of completely following the positioning members 811.

That is to say, when transitioning from the state illustrated in FIGS. 9A, 9B, and 10 to the state illustrated in FIGS. 11A, 11B, and 12, the pins 27a to 27c are disengaged from the groove portions 261a to 263a, and move to the opened portions 261d to 263d serving as widened hole portions where the movable range is enlarged in the holes 261 to 263. In this state, the pins 27a to 27c are capable of relative movement as to the holes 261 to 263 over a wide range. Accordingly, by the force acting on the abutting portions from the positioning members, the biasing force acting on the plate 52 from the biasing members, and so forth, being balanced, the recording head 22 is supported by the head holder 26 in a second supporting mode in which posture change that follows the positioning members 811 is enabled. This posture change includes relative rotation about the rotational axis line in the sheet width direction (width direction of the recording head 22) with respect to the head holder 26, and relative movement in the direction (sheet conveyance direction) that intersects each of the movement direction of the head holder 26 and the sheet width direction.

Thus, the recording head 22 finally is in a state of completely following the positioning members 811 of the conveying portion, and accordingly highly precise positioning of the recording head 22 and the conveying portion can be performed. Note, however, that biasing force of the first to third biasing members 51a to 51c is not necessarily indispensable, and that a configuration may be made in which positioning is performed by the recording head 22 being biased under its own weight.

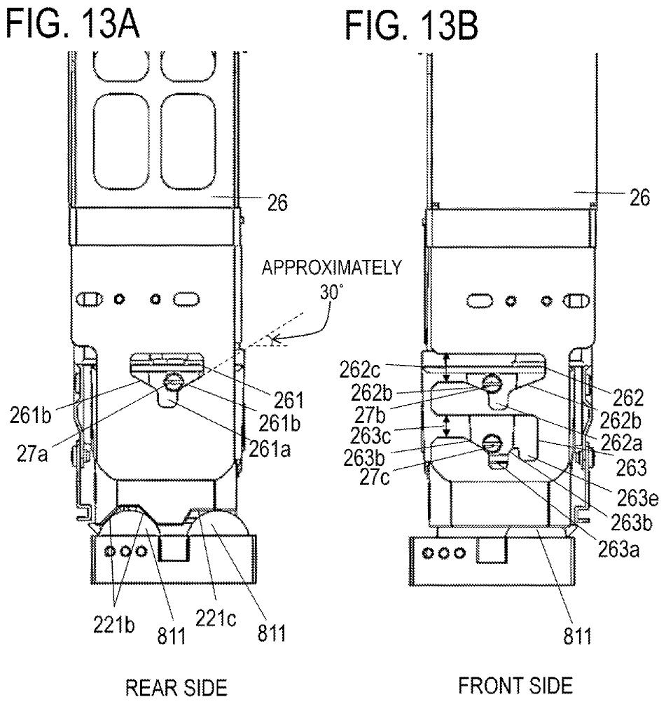

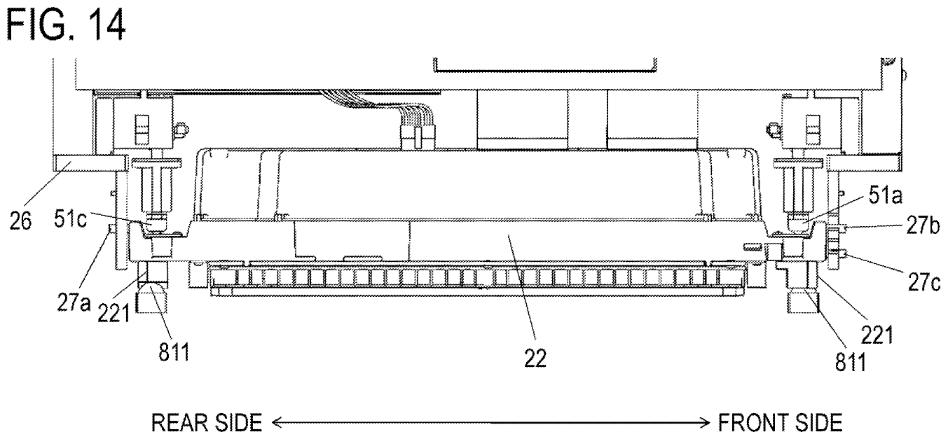

FIGS. 13A, 13B and 14 are diagrams illustrating a state in which the head holder 26 rises from the printing position, and the recording head 22 is beginning to be retracted upward. FIG. 13A is a diagram as viewed from the apparatus rear side, FIG. 13B is a diagram as viewed from the apparatus front side, and FIG. 14 is a diagram as viewed from the downstream side in the sheet conveyance direction. FIGS. 13A and 13B illustrate a state in which the head holder 26 and the positioning members 811 are misaligned in the longitudinal direction (the direction that intersects each of the movement direction of the head holder 26 and the sheet width direction, the direction in the sheet conveyance direction), due to variance in precision of related parts of the apparatus main body. At this time, the first pin 27a and the first groove portion 261a, the second pin 27b and the second groove portion 262a, and the third pin 27c and the third groove portion 263a, are also each misaligned in the longitudinal direction. Accordingly, when the recording head 22 is raised by the head holder 26 rising, any one of or all of the first pin 27a and the first inclined portion 261b, the second pin 27b and the second inclined portion 262b, and the third pin 27c and the third inclined portion 263b, come into contact, in the state such as illustrated in FIGS. 13A and 13B.

When the head holder 26 further rises from such a state, the first pin 27a is guided into the first inclined portion 261b under either of the biasing force of the first to third biasing members 51a to 51c or the weight of the recording head 22 itself, or under both, and enters the first groove portion 261a. Note that the second biasing member 51b is placed at the position illustrated in FIG. 4, and omitted from illustration in FIG. 14 due to overlapping thereof with the third biasing member 51c. The above described applies to the second pin 27b and the third pin 27c in the same way. That is to say, the supporting mode of the recording head 22 by the head holder 26 will change from the second supporting mode in which posture change of the recording head 22 to follow the positioning members 811 is permitted, to the first supporting mode in which the posture change of the recording head 22 is restricted. Accordingly, the recording head 22 can move from the printing position to the retracted position in a stable posture with rotation as to the head holder 26 being restricted.

The inclination angle of the inclined faces of the first inclined portion 261b (angle as to the direction (sheet conveyance direction) orthogonal to each of the direction of moment of the head holder 26 and the width direction of the recording head 22) is approximately 30° in the Present Example. Note, however, that the inclination angle is limited to this, and a minimally necessary angle is found in accordance with the weight and center-of-gravity position of the recording head 22, the biasing forces of each of the biasing members 51a to 51c, and frictional force between the first pin 27a and the first inclined portion 261b. This applies to the second inclined portion 262b and the third inclined portion 263b as well, in the same way as the first inclined portion 261b.

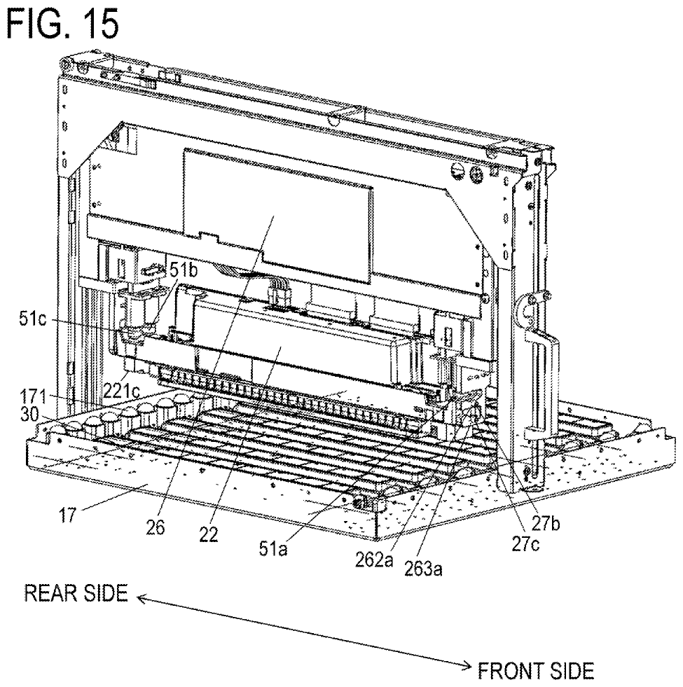

Next, positioning of the recording head 22 and the maintenance portion 17 will be described with reference to FIG. 15. FIG. 15 is a perspective view illustrating a state in which the maintenance portion 17 has moved to below the recording head 22 that is in the retracted state. From this state, the recording head 22 descends toward the maintenance position serving as the positioning position, in the same way as the positioning as to the conveying portion. Accordingly, the first abutting portion 221a (omitted from illustration), the second abutting portion 221b (omitted from illustration), and the third abutting portion 221c of the recording head 22 first abut against the positioning members 171 of the maintenance portion 17. Thereafter, by descending further, the first abutting portion 221a, the second abutting portion 221b, and the third abutting portion 221c of the recording head 22 are biased against the positioning members 171 by the first biasing member 51a, the second biasing member 51b, and the third biasing member 51c, provided to the head holder 26, and the recording head 22 is thus positioned. At this time, the first pin 27a (omitted from illustration), the second pin 27b, and the third pin 27c are released from the first groove portion 261a (omitted from illustration), the second groove portion 262a, and the third groove portion 263a, of the head holder 26. As a result, the first abutting portion 221a (omitted from illustration), the second abutting portion 221b (omitted from illustration), and the third abutting portion 221c are in a state of completely following the positioning members 171 provided to the maintenance portion 17. Thus, positioning of the recording head 22 and the maintenance portion 17 can be performed with high precision.

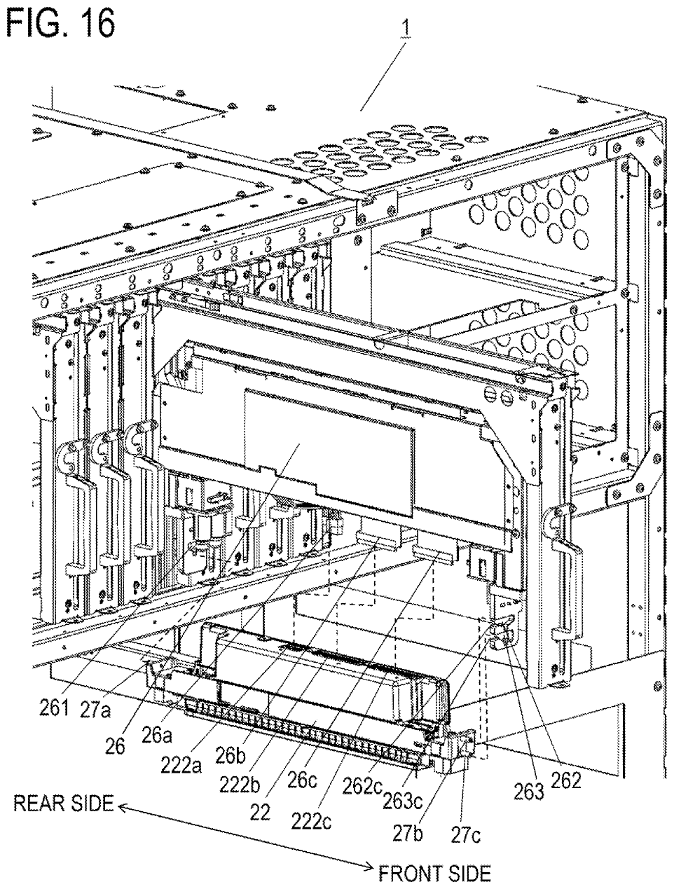

Attachability of Recording Head Next, attaching work at the time of setting the recording head 22 in the recording apparatus 1 will be described with reference to FIG. 16. FIG. 16 is a perspective view illustrating a state before attaching the recording head 22 to the apparatus main unit of the recording apparatus 1. As illustrated in FIG. 16, setting the recording head 22 in the recording apparatus 1 is performed in a state in which the head holder 26 is first drawn out from the recording apparatus 1 to the near side in the sheet width direction.

When attaching the recording head 22 to the head holder 26, first, the first pin 27a provided to the recording head 22 is inserted into the first hole 261 of the head holder 26. Thereafter, the second pin 27b is guided into the second hole 262 from the second notch portion 262c of the head holder 26, and also the third pin 27c is guided into the third hole 263 from the third notch portion 263c. Further, the first pin 27a, the second pin 27b, and the third pin 27c are respectively made to be supported by the first groove portion 261a, the second groove portion 262a, and the third groove portion 263a. Thus, the recording head 22 can be attached to the head holder 26 in a state in which the posture of the recording head 22 as to the head holder 26 is set. At this time, the first pin 27a and the first hole 261 are placed at the far side in the sheet width direction, and the second pin 27b and the third pin 27c, and the second hole 262 and the third hole 263, are placed at the near side in the sheet width direction, as illustrated in FIG. 16. Accordingly, only insertion of the first pin 27a into the first hole 261 is necessary at the far side, away from the fingertips of the worker, and work of guiding the second pin 27b and the third pin 27c into the second hole 262 and the third hole 263, respectively, is performed at the near side close thereto. Accordingly, the recording head 22 can be easily set in the head holder 26.

Next, work of electrically connecting the recording head 22 and the recording apparatus 1 will be described. Electrical connector connection portions 222a, 222b, and 222c are provided on an upper face of the recording head 22, as illustrated in FIG. 16. Also, electrical connectors 26a, 26b, and 26c are placed on the head holder 26 at positions facing the electrical connector connection portions 222a, 222b, and 222c. Thus, providing the electric connection portions for electrical connection between the recording head 22 and the recording apparatus 1 on the upper face of the recording head 22 enables the width of the recording head 22 in the longitudinal direction to be reduced, and the width of the overall recording apparatus 1 in the longitudinal direction can be reduced.

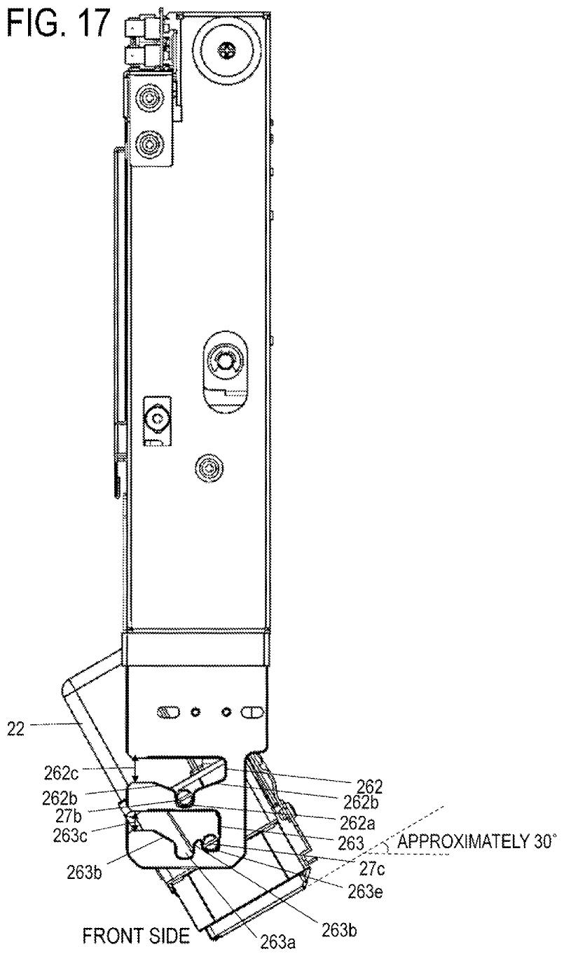

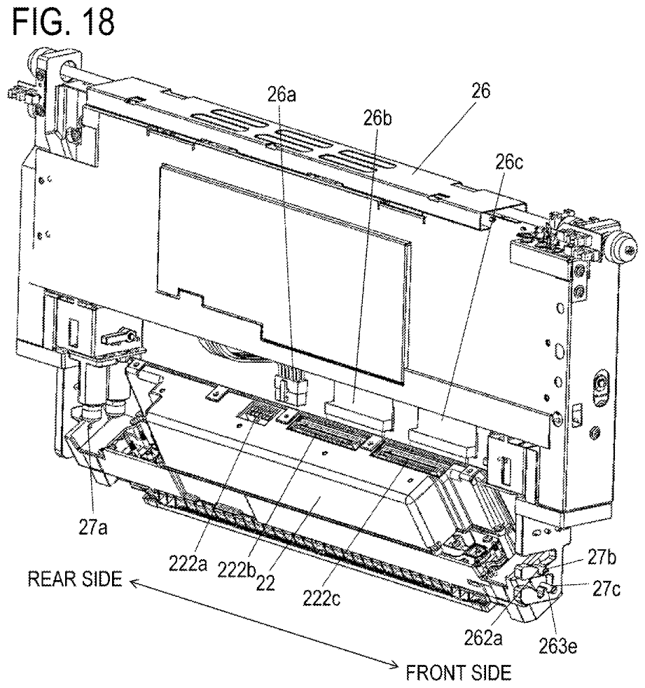

Next, as illustrated in FIGS. 17 and 18, the third pin 27c of the recording head 22 supported by the head holder 26 is set in the fourth groove portion 263e, whereby the recording head 22 can be held inclined as to the head holder 26. FIG. 17 is a diagram illustrating the apparatus front side, in a state in which the recording head 22 is held inclined as to the head holder 26. FIG. 18 is a perspective view of the recording head 22 being held inclined.

As illustrated in FIG. 18, enabling the recording head 22 to be held inclined allows the worker to easily confirm the electrical connector connection portions 222a, 222b, and 222c provided on the upper face of the recording head 22. Also, the recording head 22 is held in a state in which the electrical connector connection portions 222a, 222b, and 222c are inclined and exposed toward the worker side, and accordingly connection thereof to the electrical connectors 26a, 26b, and 26c provided on the recording apparatus 1 side is facilitated.

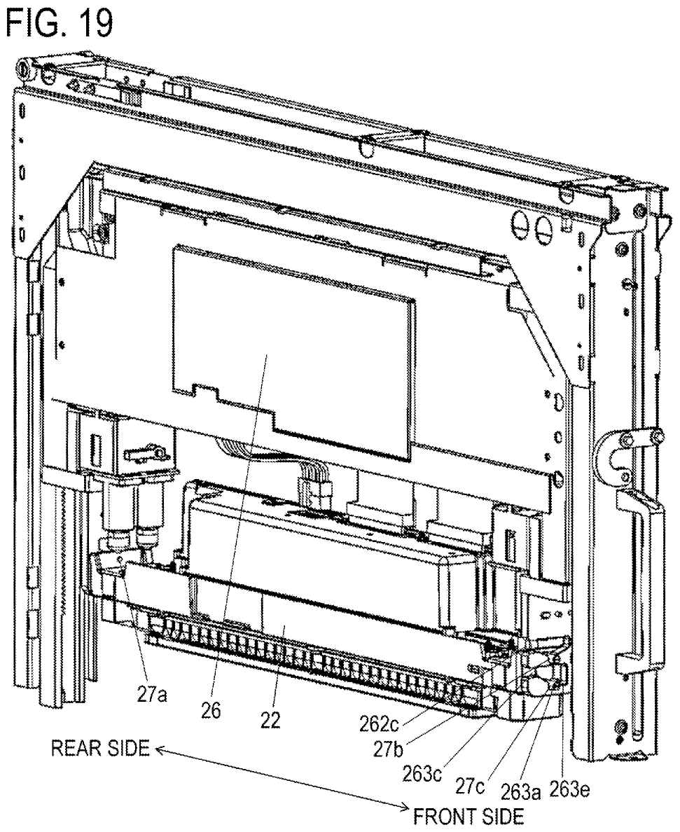

FIG. 19 is a diagram in which the electrical connectors 26a, 26b, and 26c are connected to the recording head 22, and the inclination of the recording head 22 is returned to the normal state by moving the third pin 27c of the recording head 22 from the fourth groove portion 263e to the third groove portion 263a. The work above completes attachment of the recording head 22 to the recording apparatus 1 and work of electrical connection thereof to the recording apparatus 1.

Note that in the Present Example, the fourth groove portion 263e is provided such that the recording head 22 is held inclined by an inclination angle as to the discharge orifice face (angle as to a direction (sheet conveyance direction) that is orthogonal to each of the moving direction of the head holder 26 and the width direction of the recording head 22) of substantially 30°, as illustrated in FIG. 19. This is only an example, and is not limiting. That is to say, it is sufficient for the fourth groove portion 263e to be formed at a position sufficiently distanced from the third groove portion 263a, such that the third pin 27c does not fall therein when the recording head 22 moves from the printing position or the maintenance position to the retracted position.

As described above, according to the Present Example, the recording head 22 is held by the head holder 26 in a stable manner at the retracted position. Further, at the printing position or the maintenance position, the movable range of the recording head 22 as to the head holder 26 is expanded, and is positioned fully following the conveying portion or the maintenance portion 17. Accordingly, positioning of the recording head 22 as to the conveying portion or the maintenance portion 17 can be performed with high precision. Also, at the time of the recording head 22 being set to the recording apparatus 1, setting can be easily performed through the second notch portion and the third notch portion provided to the head holder 26. Further, hooking the third pin 27c on the fourth groove portion 263e enables the recording head 22 to be held in an inclined state, and connection work to the electrical connectors 26a, 26b, and 26c is facilitated.

According to the Present Example, a guide mechanism, with a high level of general-use versatility can be realized, in which the recording head 22 can be made to follow and to be positioned as to the counter unit. That is to say, movement of the head holder 26 that supports the recording head 22 is a simple moving configuration of which the movement direction thereof is only in a linear direction. By the recording head 22 abutting the positioning members 811, the supporting mode of the recording head 22 by the head holder 26 changes from the first mode in which rotation of the recording head 22 is restricted to the second mode in which rotation thereof is permitted. This configuration is realized by refining the engagement configuration of the pins 27 of the recording head 22 and the holes 261 to 263 of the head holder 26. That is to say, the holes 261 to 263 are configured having the groove portions 261a to 263a that restrict movement of the pins 27 in the lateral direction that intersects the movement direction of the head holder 26, and the opened portions 261d to 263d that permit lateral-direction movement of the pins 27 within a predetermined range. The change in the supporting mode described above is enabled by the configuration in which the engagement positions of the pins 27 as to the holes 261 to 263 change by the recording head 22 moving relative to the head holder 26 due to abutting the positioning members 811.

Also, although a configuration has been described in the Present Example regarding the positioning abutting configuration in which the abutting portions are recessed forms and the positioning portions are protruding forms, and positioning is performed by fitting the recesses and the protrusions, this configuration is not limiting. For example, the abutting portions may be protruding forms and the positioning portions may be recessed forms, or a combination may be made in which part of a plurality of the abutting portions are recessed forms and the rest are protruding forms, and correspondingly, part of the positioning portions are protruding forms and the rest are recessed forms.

Also, the specific forms of the recessed forms of the abutting portions, i.e., the combination of placement of cones and grooves may be in a layout that is different from that in the Present Example. In the Present Example, the abutting portion 221b serving as a first abutting portion that is provided on the same side as the abutting portion 221c serving as a second abutting portion in the sheet width direction (recording head longitudinal direction) is a groove form portion, and the abutting portion 221a serving as a first abutting portion that is provided on the opposite side is a recessed conical portion. Conversely, for example, the abutting portion 221a may be changed from a recessed conical portion to a groove form portion, and the abutting portion 221b may be changed from a groove form portion to a recessed conical portion.

Note that in the Present Example, a configuration is made in which the side on which the abutting portion 221a having a conical form is provided is a reference point side at the time of recording operations by the recording head 22, and the side on which this conical portion is provided and a conveyance reference side for sheets in the sheet width direction are on the same side. That is to say, a configuration is made in which the positioning configuration to serve as the operation reference point side of the recording head 22 is an engaging configuration of the abutting portion 221a that is a conical recessed portion, and the positioning member 811a that is a partially spherical protruding portion, thereby restricting the position of each other in the sheet conveyance direction and the sheet width direction. Conversely, the positioning configuration on the other side from the operation reference side of the recording head 22 is the abutting portions 221b and 221c that are groove forms opened in the sheet width direction, thereby forming a configuration in which the effects of dimensional error and so forth are accommodated (dimensional error is taken up). Thus, having the reference point for the recording head 22 and the sheet conveyance reference on the same side is preferable from the perspective of image quality in recorded images, and variance in image positions of images formed on the sheet can be reduced. Also, distancing the conical portion that serves as the reference point for the recording head 22 as far away from apparatus heat sources as possible yields a configuration in which effects of thermal deformation are not readily manifested. In the Present Example, a configuration is made in which the position for providing the conical portion is not on the apparatus rear side where there are many heat sources, such as electrical boards and so forth, but on the apparatus front side.

Also, although the abutting portion 221c serving as a second abutting portion is placed on the same side (apparatus rear side) as the abutting portion 221b in the longitudinal direction (width direction) of the recording head 22 in the Present Example, placement thereof may be on the same side (apparatus front side) as the abutting portion 221a on the opposite side.

Also, a configuration is made in the Present Example in which the first abutting portion is provided as a pair (abutting portions 221a and 221b) on both sides of the recording head in the longitudinal direction (sheet width direction), and the second abutting portion is provided only on one side in the longitudinal direction (abutting portion 221c). That is to say a configuration has been made in the Present Example in which the positioning abutting is performed by three points, but an abutting configuration may be made in which two points are provided on each side in the longitudinal direction, for a total of four points, for example. However, the abutting configuration of three points enables positioning support to be performed while taking up positional misalignment due to dimensional error of members and so forth, effects of individual variability of products and so forth can be reduced, and highly precise positioning can be enabled.

### Second Example

A recording apparatus according to a Second Example of the present invention will be described. Only configurations of the Second Example that differ from those in the First Example will be described here. Matters that are not described in particular here with regard to the configuration of the Second Example are the same as in the First Example.

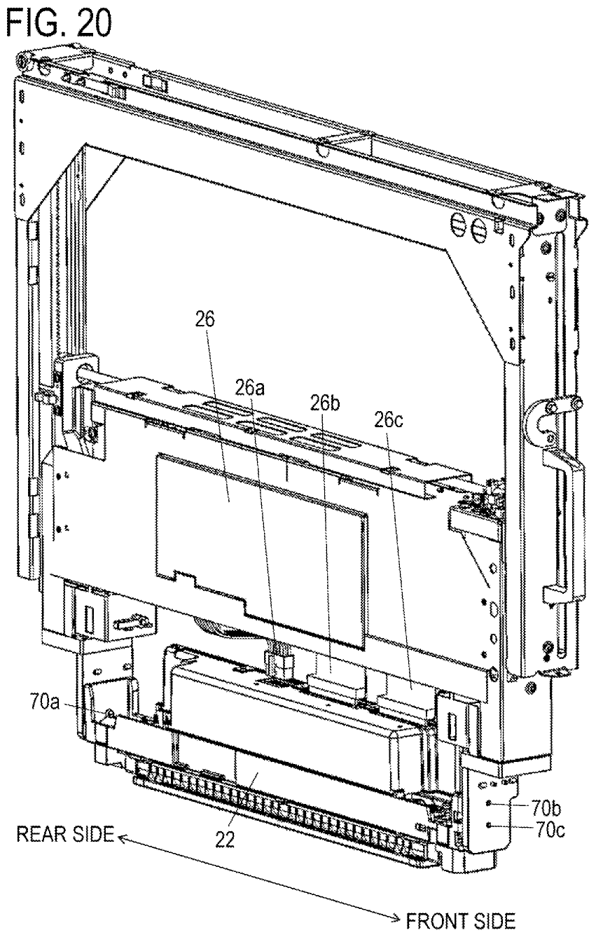

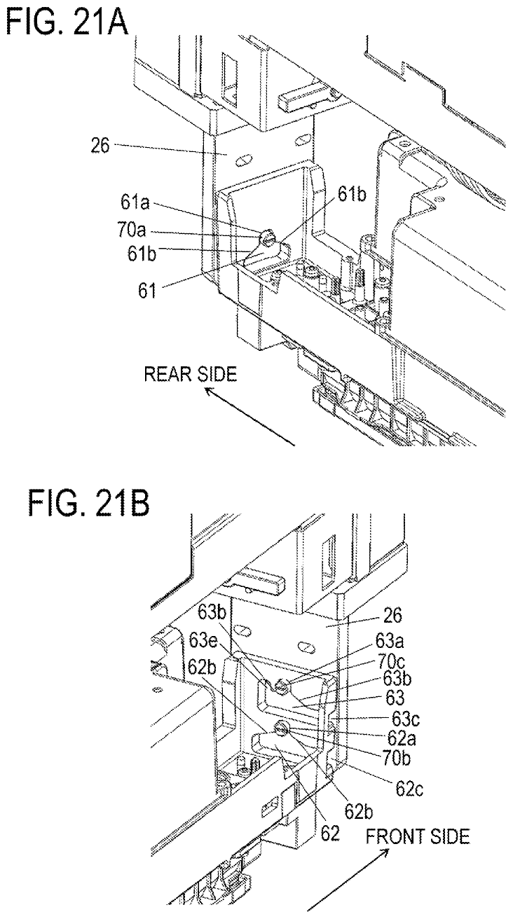

FIG. 20 is a perspective view illustrating a recording head supporting configuration according to the Second Example. FIGS. 21A and 21B are diagrams illustrating details of a recording head supporting portion according to the Second Example. FIG. 21A is a detailed diagram of the recording head supporting portion at the apparatus rear side, and FIG. 21B is a detailed diagram of the recording head supporting portion at the apparatus front side.

As illustrated in FIGS. 20, 21A, and 21B, in the Second Example, a first hole 61 is provided on one end of the recording head 22 in the sheet width direction, and a second hole 62 and a third hole 63 are provided on the other end in the sheet width direction. Also, provided on the head holder 26 supporting the recording head 22 is a first pin 70a at a position facing the first hole 61 of the recording head 22, and a second pin 70b and a third pin 70c at positions facing the second hole 62 and the third hole 63, respectively. That is to say, in the First Example, the first pin 27a, the second pin 27b, and the third pin 27c are provided to the recording head 22, and the first hole 261, the second hole 262, and the third hole 263 are provided to the head holder 26. Conversely, in the Second Example, the first hole 61, the second hole 62, and the third hole 63 are provided to the recording head 22, and the first pin 70a, the second pin 70b, and the third pin 70c are provided to the head holder 26.

Advantages the same as in the First Example can be obtained by such a configuration as well. That is to say, the recording head 22 is stably supported by the head holder 26 at the retracted position in the recording apparatus according to the Second Example as well. Further, posture change of the recording head 22 as to the head holder 26 is permitted at the printing position and the maintenance position, and is positioned completely following the conveying portion and the maintenance portion 17, and accordingly positioning to the conveying portion and the maintenance portion 17 can be performed with high precision. Also, the recording head 22 can be easily set to the recording apparatus 1 by passing the second pin 70b and the third pin 70c provided to the head holder 26 through a second notch portion 62c and a third notch portion 63c provided to the recording head 22. Further, hooking the third pin 70c on a fourth groove portion 63e enables the recording head 22 to be held in an inclined state, and accordingly connection work to the electrical connectors 26a, 26b, and 26c is facilitated.

Configurations of Examples of the present invention are not limited to the configurations of the First Example and the Second Example, and the First Example and the Second Example may be combined, for example. That is to say, a configuration may be made in which, for example, the first pin 27a, the second hole 62, and the third hole 63 are provided to the recording head 22, and the first hole 261, the second pin 70b, and the third pin 70c are provided to the head holder 26.

### Third Example

A recording apparatus according to a Third Example of the present invention will be described. Basically, only configurations of the Third Example that differ from those in the First and Second Examples will be described here. Matters that are not described in particular here with regard to the configuration of the Third Example are the same as in the First Example.

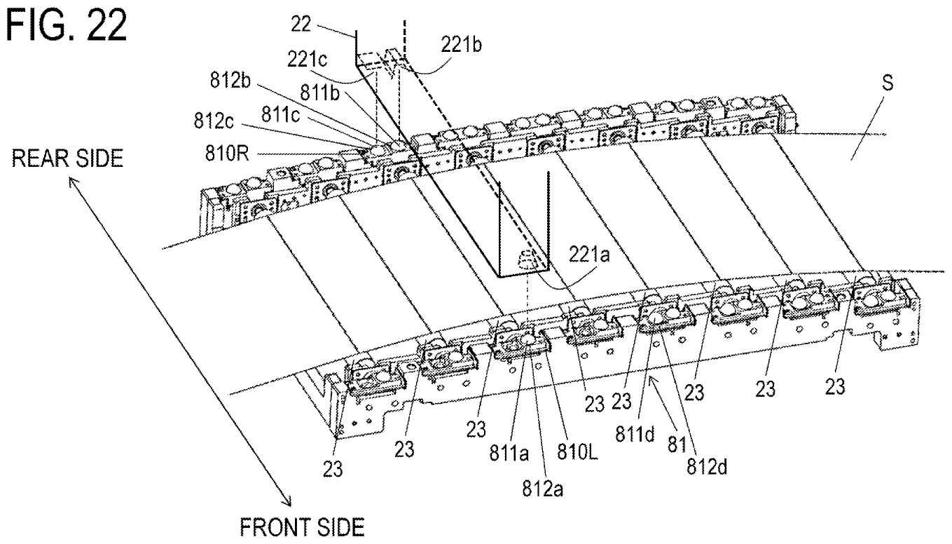

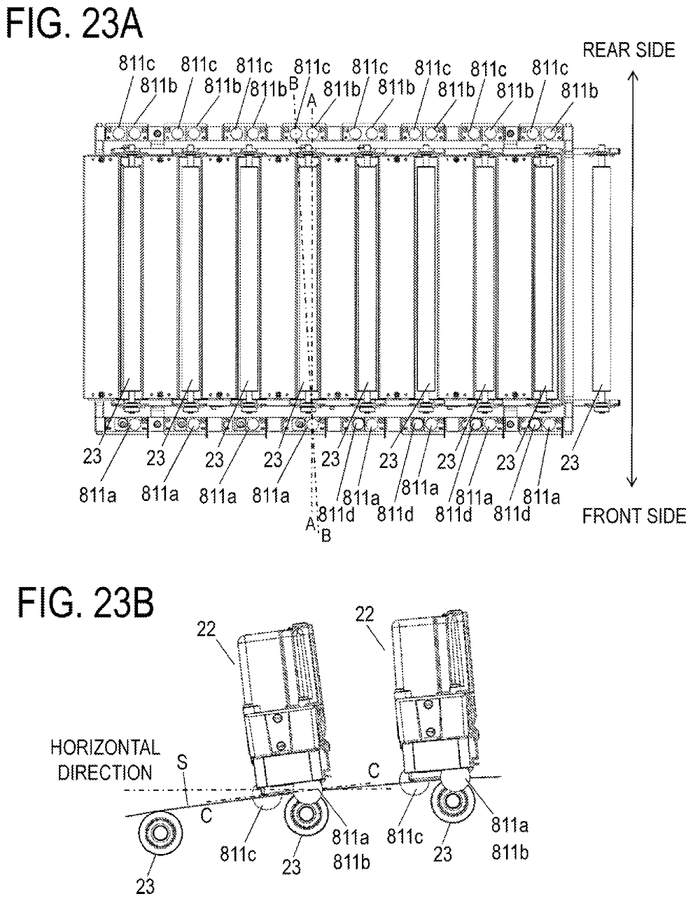

FIG. 22 is a perspective view of the sheet conveying portion chassis 81 of the recording portion 8 according to the Third Example. FIG. 23A is a diagram illustrating the sheet conveying portion chassis 81 as viewed from above the apparatus. FIG. 23B is a diagram illustrating a relation among the sheet S, the recording heads 22, and the guide rollers 23. As illustrated in FIG. 22, the sheet conveying portion chassis 81 serving as a conveyance unit is provided with a plurality of each of the first positioning member 811a, the second positioning member 811b, and the third positioning member 811c, for positioning of the recording heads 22 at the printing position (recording position). For each recording head 22 there is provided the first positioning member 811a on the near side (apparatus front side) across the sheet S in the sheet width direction that is orthogonal to the sheet conveyance direction, and the second positioning member 811b and the third positioning member 811c are provided on the far side (apparatus rear side).

One positioning portion that includes one set of the first positioning member 811a, the second positioning member 811b, and the third positioning member 811c, as a plurality of positioning abutting portions, is configured for each recording head 22. That is to say, a plurality of the positioning portions are provided to the sheet conveying portion chassis 81 corresponding to the plurality of the recording heads 22. Part of the plurality of positioning portions include, in addition to the three positioning members 811a, 811b, and 811c, a restricting member 811d serving as a restricting portion that restricts the posture of the recording head 22 when moving and positioning the recording head 22.

The first positioning member 811a, the second positioning member 811b, the third positioning member 811c, and the restricting member 811d are each spherical members of the same diameter as each other. The first positioning member 811a, the second positioning member 811b, the third positioning member 811c, and the restricting member 811d, are each attached by being fit into the recessed portions 812 provided in the positioning supporting portions 810 that the sheet conveying portion chassis 81 has. Substantially downward (lower hemisphere) portions of the first positioning member 811a, the second positioning member 811b, the third positioning member 811c, and the restricting member 811d are each embedded in the recessed portions 812, and substantially upward (upper hemisphere) portions that are exposed from the recessed portions 812 form protruding-form positioning portions that have substantially hemispherical forms protruding upward. The positioning supporting portion 810 includes the near-side positioning supporting portion 810L that is placed on the near side in the sheet width direction with respect to the sheet conveyance path, and the far-side positioning supporting portion 810R that is placed on the far side. The first positioning member 811a is attached to the first recessed portion 812a provided in the near-side positioning supporting portion 810L. The second positioning member 811b is attached to the second recessed portion 812b provided in the far-side positioning supporting portion 810R, and the third positioning member 811c is attached to the third recessed portion 812c provided in the far-side positioning supporting portion 810R. The second recessed portion 812b is provided on the upstream side in the sheet conveyance direction as to the third recessed portion 812c. The restricting member 811d is attached to a fourth recessed portion 812d provided in the near-side positioning supporting portion 810L. The fourth recessed portion 812d is provided on the downstream side in the sheet conveyance direction with respect to the first recessed portion 812a.

As illustrated in FIG. 23A, the first positioning member 811a and the second positioning member 811b are placed such that a straight line A-A passing through the center of the first positioning member 811a and through the center of the second positioning member 811b is parallel to rotational axis lines of the guide rollers 23. Also, the third positioning member 811c is placed on the downstream side from the first positioning member 811a and the second positioning member 811b in the sheet conveyance direction, as illustrated in FIGS. 23A and 23B. As illustrated in FIG. 23A, the third positioning member 811c is placed such that a straight line B-B that passes through the center thereof and the center of the first positioning member 811a has a predetermined angle as to the straight line A-A that passes through the center of the first positioning member 811a and the center of the second positioning member 811b. Also, as illustrated in FIG. 23B, the third positioning member 811c is placed such that a straight line C-C that passes through the center thereof and the center of the first positioning member 811a or the center of the second positioning member 811b has a predetermined angle as to the horizontal direction.

That is to say, in the raising/lowering movement direction of the recording head 22, the third positioning member 811c is placed at an optional relative height with respect to the first positioning member 811a and the second positioning member 811b. The placement of the third positioning member 811c with respect to the first positioning member 811a and the second positioning member 811b is set such that the nozzle plate (omitted from illustration) of the recording head 22 situated at the printing position can be positioned so as to be parallel to the sheet S supported by the plurality of guide rollers 23. That is to say, the placement position of the third positioning member 811c is set such that the recording head 22 at the printing position is positioned at a posture inclined by a predetermined angle at a predetermined recording position. The predetermined angle here is an angle in which the nozzles (discharge orifices) of the nozzle plate face the recording face of the sheet S perpendicularly (the nozzle face at which the nozzles open (discharge orifice face) is parallel as to the recording face). The first positioning member 811a, the second positioning member 811b, and the third positioning member 811c are each spheres with the same diameter, as described above, and the center of each is the center of the respective sphere.

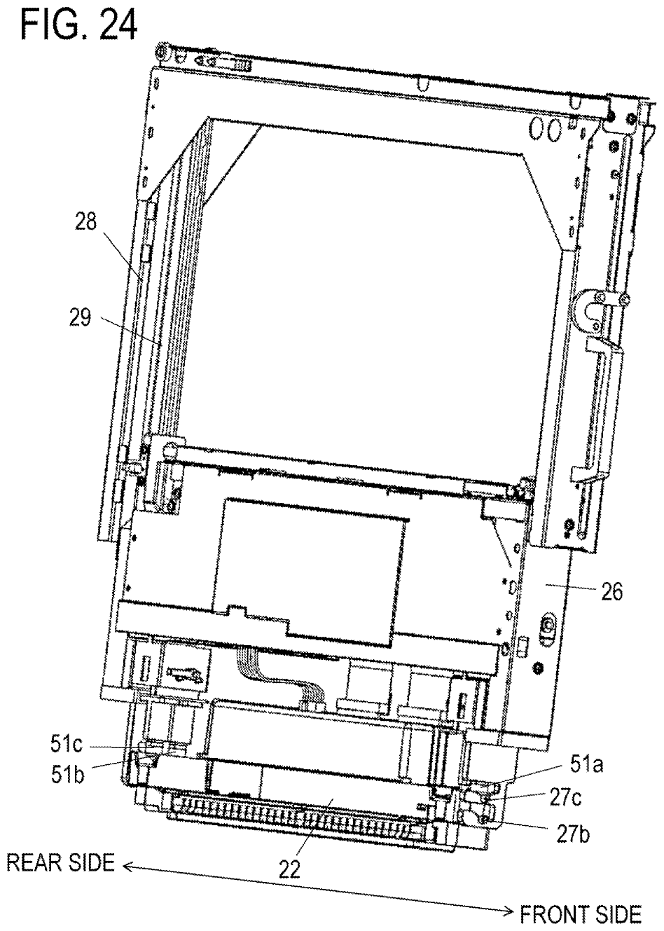

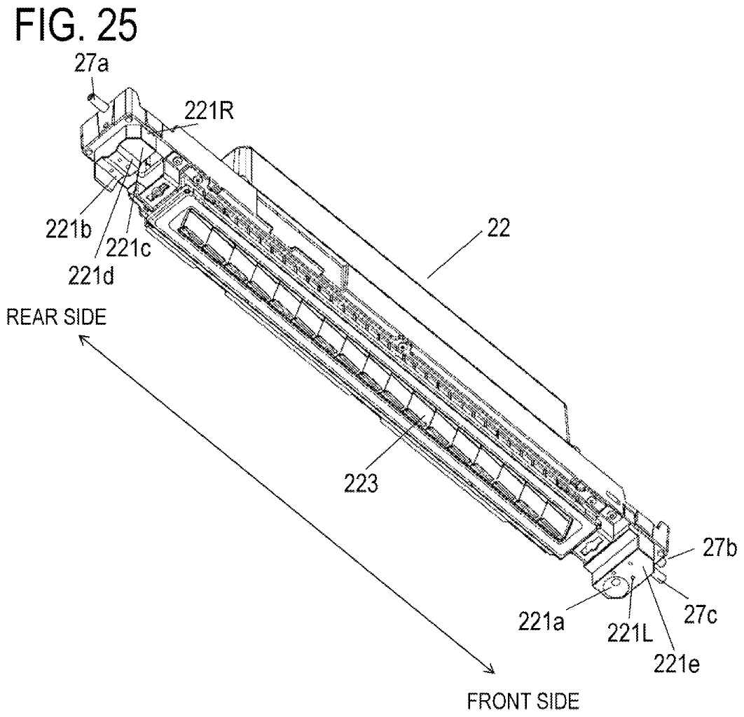

As illustrated in FIG. 24, the recording head 22 is held by the head holder 26 that serves as a moving portion, and is configured to perform raising/lowering movement, up and down, by movement of the head holder 26. The recording head 22 is provided with the first pin 27a (see FIG. 25, etc.), the second pin 27b, and the third pin 27c, serving as supported portions. The first pin 27a is a protruding portion that, out of both ends of the recording head 22 in the longitudinal direction (width direction) of the recording head 22 that intersects each of the raising/lowering direction of the recording head 22 and the sheet conveyance direction, protrudes from one end portion (apparatus front side) in the width direction. The second pin 27b and the third pin 27c are protruding portions that respectively protrude in the longitudinal direction from the other end portion (apparatus rear side) in the longitudinal direction of the recording head 22. The recording head 22 is axially supported with respect to the head holder 26, by the first pin 27a, the second pin 27b, and the third pin 27c being respectively supported from below by the first hole 261, the second hole 262, and the third hole 263 provided in the head holder 26.

Further, the recording head 22 is supported by the head holder 26 in a state of being biased downward by the first biasing member 51a, the second biasing member 51b, and the third biasing member 51c, which are provided on the head holder 26 and include compression springs. The configurations of the first biasing member 51a, the second biasing member 51b, and the third biasing member 51c will be described later. The head holder 26 performs raising/lowering operations in the up-down-direction along rails 29 for raising/lowering that are provided within the recording head raising/lowering frame 28, by the internally-provided driving mechanism that is omitted from illustration. That is to say, the plurality of recording heads 22 are each capable of raising/lowering movement independently from each other, by its own head holder 26 and its own raising/lowering driving mechanism, and the recording heads 22 are configured so as to be capable of optionally changing relative positions as to each other.

Recording Head Configuration

FIG. 25 is a perspective view of the recording head 22. As illustrated in FIG. 25, the recording head 22 has a plurality of the nozzle plates 223 that have the plurality of nozzles (discharge orifices) that discharge ink, placed arrayed in the longitudinal direction (sheet width direction) of the recording head. Also, the positioned portions 221L and 221R are provided on respective ends of the recording head 22 in the longitudinal direction (direction orthogonal to the sheet conveyance direction). Specifically, the positioned portion 221L on the near side in the head longitudinal direction (apparatus front side) is provided with the first abutting portion 221a that is made of a recessed-form portion having a conical inclined face. Also, the positioned portion 221R on the far side in the head longitudinal direction (apparatus rear side) is provided with the second abutting portion 221b that is made of a groove-form portion that has two flat faces in a substantial letter-V form and that extends in the head longitudinal direction, and the third abutting portion 221c that is made of a planar portion, the second abutting portion 221b and the third abutting portion 221c being arrayed in the sheet conveyance direction.

Now, a guide form portion 221d is provided near the third abutting portion 221c that is made of a planar portion. The guide form portion 221d is configured with a form such that, in a case in which sliding occurs at the recording head 22 at the time of the third abutting portion 221c and the third positioning member 811c abutting, and misalignment occurs, the third positioning member 811c can be guided to the third abutting portion 221c. In the Present Example, the guide form portion 221d is made of a guide face that is inclined as to and continues to the face making up the third abutting portion 221c. This guide form portion 221d suppresses a situation from occurring in which the abutting portions 221a to 221c do not fit to the positioning members 811a to 811c due to misalignment of the recording head 22, and positioning cannot be performed.

Also, a fourth abutting portion 221e is provided near the first abutting portion 221a, to serve as a restricted portion that abuts the restricting member 811d serving as a restricting portion, which will be described later.

In the longitudinal direction of the recording head 22, a straight line passing through the center of the first abutting portion 221a and the center of the second abutting portion 221b is placed so as to be in parallel with the array of the plurality of nozzle plates 223 of the recording head 22 with good precision. Now, the centers of each of the first abutting portion 221a and the second abutting portion 221b are the centers of each of hypothetical spheres of the same diameter that are each in contact therewith internally. The third abutting portion 221c is placed at a position away from the second abutting portion 221b in the sheet conveyance direction (direction orthogonal to the longitudinal direction of the recording head 22).

Operations of Recording Head

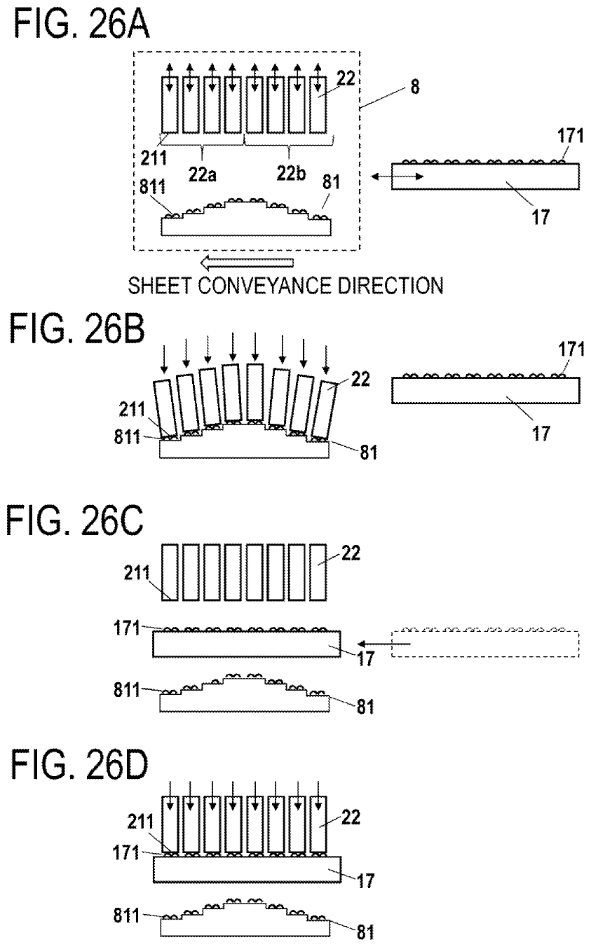

Positioning operations of the recording heads 22 in the recording apparatus according to the Present Example will be described with reference to FIGS. 26A to 26D. FIGS. 26A to 26D are schematic explanatory diagrams illustrating operation examples involving positioning of the recording heads 22.

FIG. 26A is a schematic diagram illustrating a state in which the recording heads 22 are in the retracted position retracted upward from the sheet conveying portion chassis 81, as a non-recording position and a non-positioning position, and the maintenance portion 17 is in the non-maintenance position retracted substantially parallel from the recording heads 22 in the sheet conveyance direction.

FIG. 26B is a schematic diagram illustrating a state in which the recording heads 22 are in the printing position for recording images on the sheet S, as a recording position. In a case of the recording heads 22 moving from the retracted position to the printing position, the recording heads 22 move substantially vertically downward from the upward retracted position, by the above-described recording head raising/lowering mechanism. The positioned portions 221 of the recording heads 22 abut the positioning members 811a to 811c serving as a first positioning portion provided to the sheet conveying portion chassis 81, and descend to the printing position (first position) at which the orientations of the recording heads 22 are postures of predetermined angles and positioned.

As illustrated in FIG. 26B, in the Present Example, an array of a plurality of the positioning members 811 of the sheet conveying portion chassis 81 in the sheet conveyance direction is configured as a hill-like array in a substantially arc form that gradually increases height downstream in the conveyance direction, passes a peak, and gradually becomes lower. In this case, there is a need to cause the plurality of recording heads 22 to each descend to a different height. In the height control of the plurality of recording heads 22, an additional descent amount of for each individual recording head 22 of the plurality of recording heads 22 is set from an initial position of descent to a detection position by a position detection sensor (omitted from illustration) provided to the apparatus main unit, for example. Accordingly, the plurality of recording heads 22 can be moved so as to be arrayed at heights different from each other, in accordance with the plurality of positioning members 811 arrayed in an arc form. Further, the plurality of recording heads 22 are configured so as to be able to assume postures with different angles from each other with respect to the orientation of the ink discharge faces thereof, and are configured to be able to assume postures of different angles between a first angle of the ink discharge face of a recording head 22a as to the horizontal direction and a second angle of the ink discharge face of a recording head 22b as to the horizontal direction, for example. The ink discharge faces that the recording heads 22 have are placed so as to continue as a substantial arc form along the sheet conveyance path that is configured in a substantial arc form (first relative placement).

FIG. 26C is a schematic diagram illustrating a state in which the recording heads 22 are in the retracted position, and the maintenance portion 17 has moved to the maintenance position. In a case of performing capping of the recording heads 22 after completing printing, or in a case in which nozzles of the recording heads 22 become clogged and ink discharge defects occur or the like, maintenance operations of the recording heads 22 are carried out by the maintenance portion 17. In a case of carrying out maintenance operations, first, the recording heads 22 and the maintenance portion 17 move to their respective retracted positions, as illustrated in FIG. 26A. Thereafter, the maintenance portion 17 moves substantially horizontally in the sheet conveyance direction, and moves to the maintenance position below the recording heads 22.

FIG. 26D is a schematic diagram illustrating a state in which the recording heads 22 have moved to the maintenance position where maintenance operations thereof are carried out by the maintenance portion 17. The recording heads 22 descend substantially vertically from the state in FIG. 26C, and descend to the maintenance position at which the positioned portions 221 abut the positioning portions 171 serving as a second positioning portion that the maintenance portion 17 is provided with, and are positioned (second position). In this state, various types of maintenance operations are executed on the recording heads 22 by the maintenance portion 17.

Now, in the Present Example, the configuration of a plurality of the positioning portions 171 of the maintenance portion 17 is placement in a substantially straight line. That is to say, at the maintenance position, the plurality of recording heads 22 are placed so as to be arrayed at the same height as each other, and there is no need to move to different heights as at the printing position. Accordingly, when causing the plurality of recording heads 22 to descend to the maintenance position, an arrangement may be made in which the descent amount from the detection position of detection by the position detection sensor (omitted from illustration) of the apparatus main unit is set to the same amount as each other, and positioning operations of the plurality of recording heads 22 is performed. Further, unlike at the printing position, the orientation of the ink discharge faces of each of the plurality of recording heads 22 is the same angle as each other at the maintenance position, assuming postures in which the above-described first angle and the second angle are the same angle, for example. That is to say, a plurality of the ink discharge faces are placed so as to be continuous to each other in a substantially straight line (second relative placement).

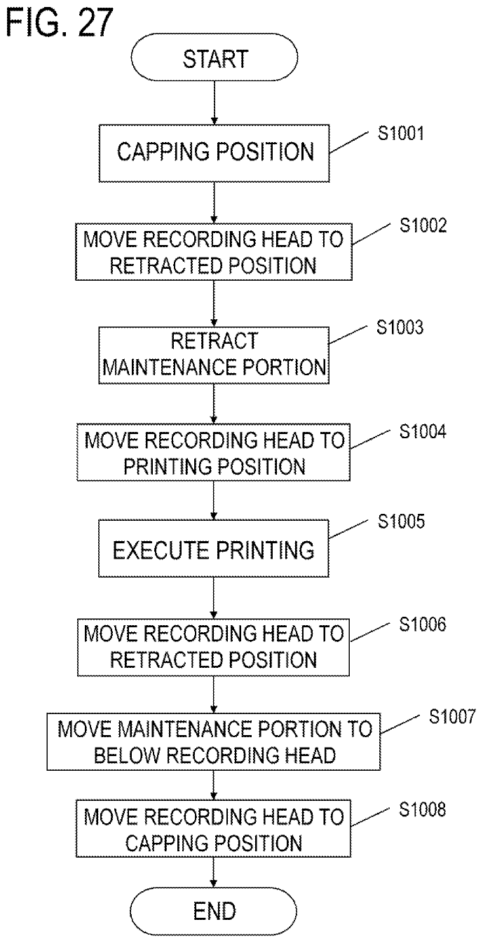

FIG. 27 is a flowchart of operations for positioning the recording heads 22 at the time of performing printing operations.

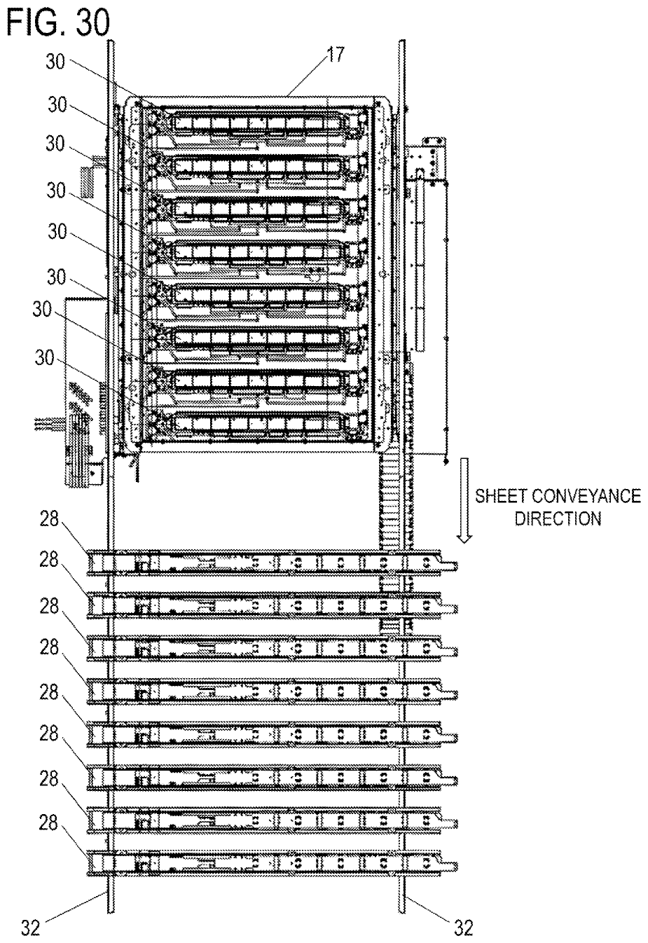

In S1001, the recording heads 22 are in a standby state at capping mechanisms 30 (see FIG. 30) of the maintenance portion 17. In S1002, the recording head moving means control portion 408 drives a motor (omitted from illustration) that raises/lowers the head holder 26, and moves (raises) the recording heads 22 from the capped position (maintenance position) to the retracted position. In S1003, the maintenance control portion 410 drives a motor (omitted from illustration) that moves the maintenance portion 17, and the maintenance portion 17 moves over maintenance portion movement rails 32 (see FIG. 30) provided on the chassis. Accordingly, the maintenance portion 17 is retracted in the horizontal direction from below the recording head 22, so that the recording heads 22 can be lowered to the printing position. In S1004, the recording head moving means control portion 408 drives the motor (omitted from illustration) that raises/lowers the head holder 26, and moves (lowers) the recording heads 22 from the retracted position to the printing position. At this time, in a case in which the plurality of positioning members 811 of the sheet conveying portion chassis 81 are placed in an arc form, the additional descent amount of the plurality of recording heads 22 for further descent from the detection position of detection by the position detection sensor (omitted from illustration) of the apparatus main unit is of individually given to each of the plurality of recording heads 22. Thus, the plurality of recording heads 22 can each be moved to different heights in accordance with the sheet conveying portion chassis 81 configured in an arc form.

In S1005, printing is executed. In S1006, the recording head moving means control portion 408 drives the motor (omitted from illustration) that raises/lowers the head holder 26, and moves (raises) the recording heads 22 from the printing position to the retracted position. In S1007, the maintenance control portion 410 drives the motor (omitted from illustration) that moves the maintenance portion 17, and the maintenance portion 17 moves over the rails 32 (see FIG. 30) provided on the chassis. Accordingly, the maintenance portion 17 is moved horizontally from the retracted position to below the recording heads 22, so that the recording heads 22 can descend to the capping position. In S1008, the recording head moving means control portion 408 drives the motor (omitted from illustration) that raises/lowers the head holder 26, and moves (lowers) the recording heads 22 from the retracted position to the capping position. This so far is the operations of positioning the recording heads 22 at the time of performing printing operations.

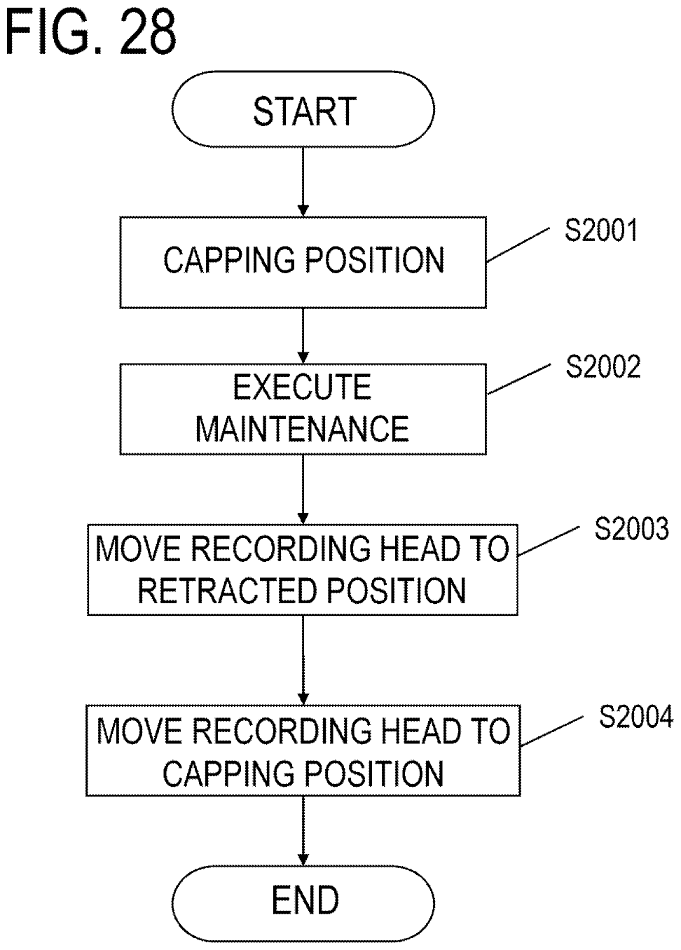

FIG. 28 is a flowchart of operations for positioning the recording heads 22 at the time of performing maintenance operations.

In S2001, the recording heads 22 are in a standby state at the capping mechanisms 30 of the maintenance portion 17. In S2002, maintenance operations are executed. In S2003, following ending maintenance, the recording head moving means control portion 408 drives the motor (omitted from illustration) that raises/lowers the head holder 26, and temporarily moves (raises) the recording heads 22 from the capping position to the retracted position. In S2004, the recording head moving means control portion 408 drives the motor (omitted from illustration) that raises/lowers the head holder 26, and moves (lowers) the recording heads 22 from the retracted position to the capping position. This so far is the operations of positioning the recording heads 22 at the time of performing maintenance operations.

Support Configuration of Recording Heads and Positioning at Printing Position

An example of a support configuration of the recording heads 22 and operations of positioning at the printing position according to the Present Example will be described in detail.

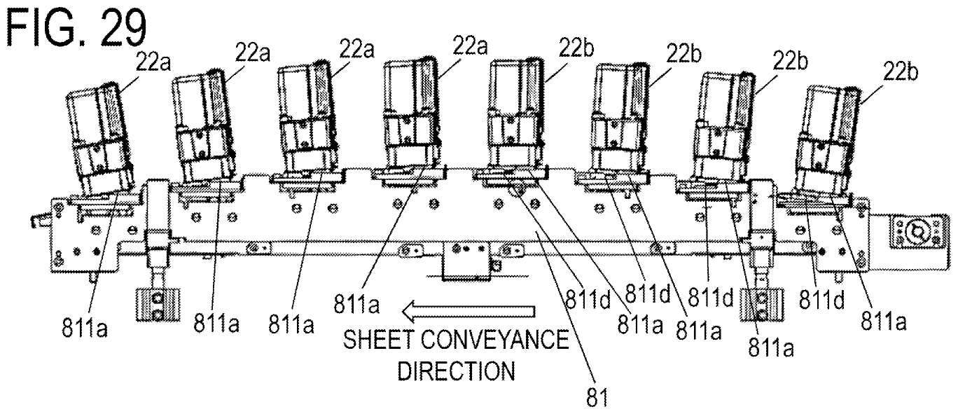

FIG. 29 illustrates a state in which the plurality of recording heads 22 are each positioned at different heights by abutting the positioning members 811 provided to the sheet conveying portion chassis 81. In the Present Example, the plurality of recording heads 22 are generally classified into two types of recording heads. As illustrated in FIG. 29, the plurality of recording heads 22 are each positioned in states of being inclined at different angles in the sheet conveyance direction following the arc form. The ink discharge faces are provided on the lower ends of each of the recording heads 22, facing the sheet conveyance path. There are first recording heads 22a in which the downstream side of the ink discharge face in the sheet conveyance direction is relatively lower than the upstream side thereof, and second recording heads 22b in which the downstream side of the ink discharge face in the sheet conveyance direction is relatively higher than the upstream side thereof. Note that depending on the configuration of the recording unit, recording heads 22 may be included in which the downstream side of the ink discharge face in the sheet conveyance direction is the same as the upstream side thereof. Also, in the following description, in a case of general description regarding configurations common to the first recording heads 22a and the second recording heads 22b, the first recording heads 22a and the second recording heads 22b may be collectively referred to as “recording heads 22”.

FIG. 30 is a diagram for describing the configuration of the maintenance portion 17, and is a diagram illustrating a planar configuration of the maintenance portion 17 as viewed from a direction perpendicular to the sheet conveyance path. Various specific configurations of the maintenance portion 17 can be included, as illustrated in FIG. 30. Examples include the capping mechanisms 30 that protect the ink discharge faces of the recording heads 22, a wiping mechanism (omitted from illustration) that performs wiping of the ink discharge faces, a suctioning mechanism (omitted from illustration) that performs negative pressure suctioning of ink inside the recording heads 22 from the ink discharge faces, and so forth. The maintenance portion 17 also includes a driving mechanism that is omitted from illustration, and the rails 32, and is capable of reciprocal movement in the horizontal direction along the rails 32. When performing maintenance of the recording heads 22, the maintenance portion 17 moves to directly below the recording heads 22, and when not performing maintenance operations, moves from directly below the recording heads 22 to a position retracted to the upstream side in the conveyance direction.

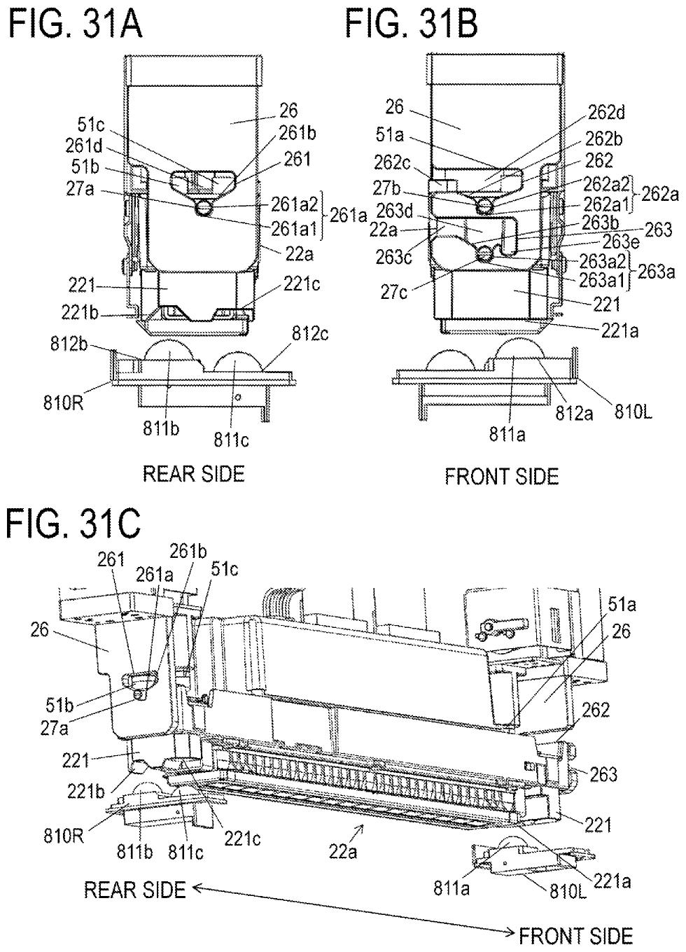

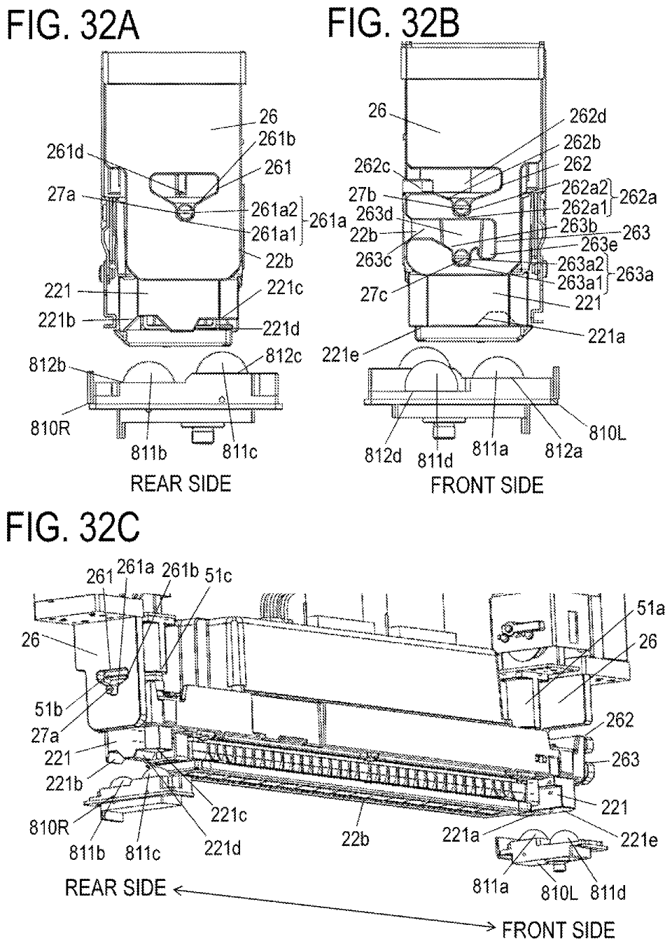

FIGS. 31A to 31C and 32A to 32C illustrate retracted states of the recording heads 22 that are retracted upward. FIGS. 31A to 31C illustrate an operation example of the first recording heads 22a, and FIGS. 32A to 32C illustrate an operation example of the second recording heads 22b. FIG. 31A is a diagram viewing the first recording head 22a and the positioning supporting portion 810 from the apparatus rear side. FIG. 31B is a diagram viewing the first recording head 22a and the positioning supporting portion 810 from the apparatus front side. FIG. 31C is a perspective view, viewing the first recording head 22a and the positioning supporting portion 810 from the downstream side in the sheet conveyance direction. FIG. 32A is a diagram viewing the second recording head 22b and the positioning supporting portion 810 from the apparatus rear side. FIG. 32B is a diagram viewing the second recording head 22b and the positioning supporting portion 810 from the apparatus front side. FIG. 32C is a perspective view, viewing the second recording head 22b and the positioning supporting portion 810 from the downstream side in the sheet conveyance direction.

The head holder 26 is provided with the first hole 261, the second hole 262, and the third hole 263. The first hole 261 is a hole portion that has a face facing as to the first pin 27a in a direction perpendicular to the longitudinal direction of the recording head 22, the second hole 262 as to the second pin 27b, and the third hole 263 as to the third pin 27c, respectively. The first hole 261, the second hole 262, and the third hole 263 are each configured having a broadly opened width as to the pin on the upper side thereof, and a narrow width in a groove form in which the pin fits on the lower side thereof.

The first hole 261 has the first groove portion 261a that is a first supporting portion for supporting the first pin 27a, the first inclined portion 261b for guiding the first pin 27a to the first groove portion 261a, and the first opened portion 261d for broadening the movable range of the first pin 27a with respect to the first hole 261. The first groove portion 261a includes the supporting face 261a1 that is a groove bottom face, and the restricting faces 261a2 that are a pair of groove side faces that face the first pin 27a so as to clamp the first pin 27a disposed on the supporting face 261al from both sides.

The second hole 262 has the second groove portion 262a that is a second supporting portion for supporting the second pin 27b, the second inclined portion 262b for guiding the second pin 27b to the second groove portion 262a, and the second opened portion 262d for broadening the movable range of the second pin 27b with respect to the second hole 262. The second groove portion 262a includes the supporting face 262al that is a groove bottom face, and the restricting faces 262a2 that are a pair of groove side faces that face the second pin 27b so as to clamp the second pin 27b disposed on the supporting face 262al from both sides.

The third hole 263 has the third groove portion 263a that is a third supporting portion for supporting the third pin 27c, the third inclined portion 263b for guiding the third pin 27c to the third groove portion 263a, and the third opened portion 263d for broadening the movable range of the third pin 27c with respect to the third hole 263. The third groove portion 263a includes the supporting face 263al that is a groove bottom face, and the restricting faces 263a2 that are a pair of groove side faces that face the third pin 27c so as to clamp the third pin 27c disposed on the supporting face 263al from both sides.

Also, in the configuration for assembling the recording head 22 to the head holder 26, the first hole 261 is a closed hole, while the second hole 262 and the third hole 263 are holes that are opened to the side at the opened portions 262d and 263d. That is to say, the second notch portion 262c is provided to the second hole 262, and the second hole 262 is opened in the direction orthogonal to the longitudinal direction of the recording head 22, such that the second pin 27b can be introduced into the second hole 262 from this direction. In the same way, the third notch portion 263c is provided to the third hole 263, and the third hole 263 is opened in a direction substantially orthogonal to the longitudinal direction of the recording head 22, such that the third pin 27c can be introduced into the third hole 263 from this direction.

Further, provided in the third hole 263 is the fourth groove portion 263e, which is used to hold the recording head 22 at an inclined posture, in order to facilitate work of electrical connection between the recording head 22 and the recording apparatus 1 when replacing the recording head 22.

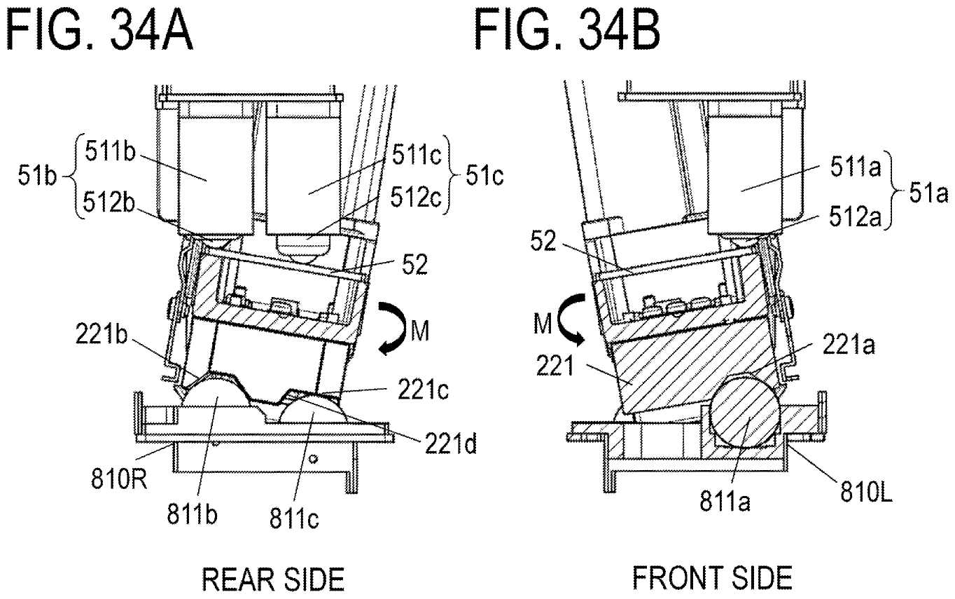

FIG. 18 is a perspective view of the recording head 22 held inclined. As illustrated in FIG. 18, the third pin 27c of the recording head 22 supported by the head holder 26 is set in the fourth groove portion 263e, whereby the recording head 22 can be held inclined as to the head holder 26. The electrical connector connection portions 222a, 222b, and 222c are provided on the upper face of the recording head 22, and electrical connectors 26a, 26b, and 26c are placed on the head holder 26 at positions facing the electrical connector connection portions 222a, 222b, and 222c. As illustrated in FIGS. 34A and 34B, enabling the recording head 22 to be held inclined allows the worker to easily confirm the electrical connector connection portions 222a, 222b, and 222c provided on the upper face of the recording head 22. Also, the recording head 22 is held in a state in which the electrical connector connection portions 222a, 222b, and 222c are inclined and exposed toward the worker side, and accordingly work of connection of the electrical connector connection portions 222a, 222b, and 222c of the recording head 22 to the electrical connectors 26a, 26b, and 26c provided on the recording apparatus 1 side is facilitated. Providing the electric connection portions for electrical connection between the recording head 22 and the recording apparatus 1 on the upper face of the recording head 22 enables the width of the recording head 22 in the longitudinal direction to be reduced, and the width of the overall recording apparatus 1 in the longitudinal direction can be reduced.

The head holder 26 is also provided with the first biasing member 51a, the second biasing member 51b, and the third biasing member 51c, for abutting the recording head 22 and imparting predetermined biasing force.

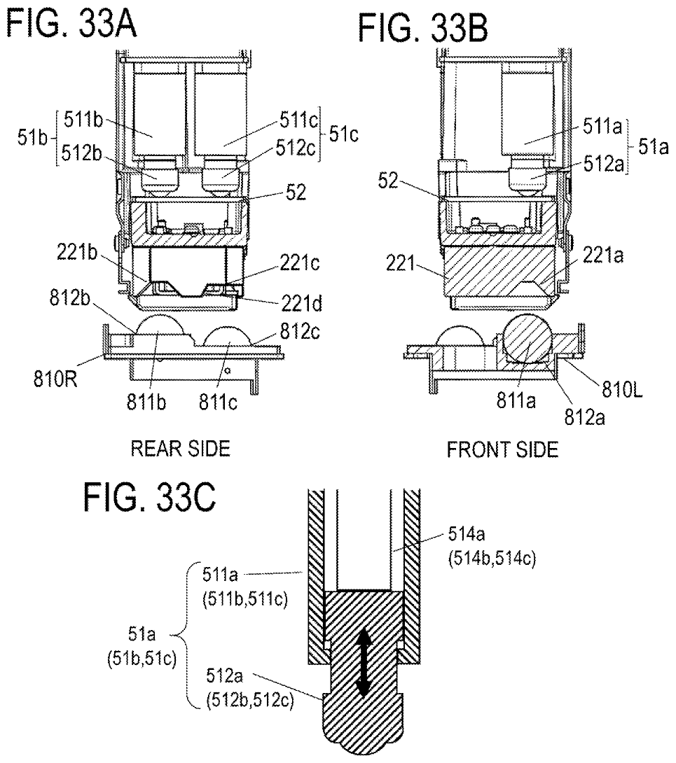

FIGS. 33A to 33C are diagrams for describing the relation between the biasing members 51a, 51b, and 51c and the first recording head 22a, at the retracted position to which the first recording head 22a has retracted upward. FIG. 33A is a diagram viewing the first recording head 22a and the positioning supporting portion 810 from the apparatus rear side. FIG. 33B is a diagram viewing the first recording head 22a and the positioning supporting portion 810 from the apparatus front side. FIG. 33C is a schematic cross-sectional view for describing the configuration of the first biasing member 51a, the second biasing member 51b, and the third biasing member 51c.

While description will be made here regarding the biasing configuration in the head holder 26 that holds the first recording head 22a, and illustration and description regarding the biasing configuration in the head holder 26 that holds the second recording head 22b will be omitted, the configuration of the latter is the same as the configuration of the former.

The first biasing member 51a is placed so as to impart the recording head 22 with biasing force at a side thereof nearer to the first abutting portion 221a or the second abutting portion 221b than the third abutting portion 221c, in the direction orthogonal to the raising/lowering direction (advancing/retracting direction) of the recording head 22 or the sheet conveyance direction. Preferably, the first biasing member 51a is placed upward of the first abutting portion 221a, i.e., at a portion that overlaps at least part of the first abutting portion 221a when viewed in the raising/lowering direction of the recording head 22. The second biasing member 51b is placed so as to impart the recording head 22 with biasing force at a side thereof nearer to the first abutting portion 221a or the second abutting portion 221b than the third abutting portion 221c, in the direction orthogonal to the raising/lowering direction (advancing/retracting direction) of the recording head 22 or the sheet conveyance direction. Preferably, the second biasing member 51b is placed upward of the second abutting portion 221b, i.e., at a portion that overlaps at least part of the second abutting portion 221b when viewed in the raising/lowering direction of the recording head 22. The third biasing member 51c is placed so as to impart the recording head 22 with biasing force at a side thereof nearer to the third abutting portion 221c than the first abutting portion 221a or the second abutting portion 221b, in the direction orthogonal to the raising/lowering direction (advancing/retracting direction) of the recording head 22 or the sheet conveyance direction. Preferably, the third biasing member 51c is placed upward of the third abutting portion 221c, i.e., at a portion that overlaps at least part of the third abutting portion 221c when viewed in the raising/lowering direction of the recording head 22.

As illustrated in FIGS. 33A to 33C, the biasing members 51a, 51b, and 51c are respectively made up of a base portion 511a, 511b, and 511c, a sliding portion 512a, 512b, and 512c, and a compression spring 514a, 514b, and 514c. The sliding portions 512a, 512b, and 512c are configured to be capable of advancing/retracting movement in a direction of biasing the recording head 22, with respect to the base portions 511a, 511b, and 511c.

As illustrated in FIG. 33C, the base portion 511 (511a, 511b, 511c) is a substantially cylindrical member, into which the sliding portion 512 (sliding portions 512a, 512b, and 512c) is partially inserted. The sliding portion 512 is configured such that the distal end portion of the side thereof that is exposed from the base portion 511 abuts the plate 52 provided on the recording head 22, and the basal end portion on the side inserted into the insertion hole portion of the base portion 511 receives biasing force from the compression spring 514 (514a, 514b, 514c). The compression spring 514 is assembled to a portion within the insertion hole portion of the base portion 511 that is deeper than where the sliding portion 512 is situated, and presses the basal end of the sliding portion 512 so as to move the sliding portion 512 from the deep side of the insertion hole toward the exit side in the raising/lowering direction of the recording head 22. The engaged portion that protrudes in a direction intersecting the insertion direction is provided on the sliding portion 512 at a part thereof that is inserted into the insertion hole of the base portion 511, and the inward-facing flange portion for preventing the sliding portion 512 from falling out is provided at the opening portion of the insertion hole of the base portion 511. Abutting engagement of the engaged portion and the flange portion with each other defines the movable range of the sliding portion 512 as to the base portion 511 in the direction of biasing the recording head 22.

The distal end portion of the sliding portion 512 is configured as a protruding portion, in which the portion that abuts the plate 52 has a protruding partial spherical face. The angle of the plate 52 that the distal end portion of the sliding portion 512 abuts changes with respect to the advancing/retracting direction of the sliding portion 512, as the posture of the recording head 22 changes. According to the above-described protruding-form configuration, when the angle of the plate 52 changes, the sliding portion 512 can change the position of contact by sliding on the plate 52 while performing advancing/retracting movement with respect to the base portion 511, and thereby maintain the state of biasing the recording head 22. Note that the shape of the distal end of the sliding portion 512 is not limited to the protruding partial spherical face such as described above, and other shape configurations may be used as appropriate, as long as a configuration in which sliding can be performed while maintaining the biasing state.

As illustrated in FIGS. 31A to 31C and 32A to 32C, the first pin 27a, the second pin 27b, and the third pin 27c of the recording head 22 in the retracted position are respectively supported by the first groove portion 261a, the second groove portion 262a, and the third groove portion 263a of the head holder 26. Further, the recording head 22 is supported in a state biased against the head holder 26 by the biasing force of the first biasing member 51a, the second biasing member 51b, and the third biasing member 51c, received by the plate 52. The pins 27a to 27c are in a state of being pressed against the supporting faces 261al to 263al that are groove bottom faces of the groove portions 261a to 263a under the biasing force of the biasing members 51a, 51b, and 51c. Also, the pairs of restricting faces 261a2 to 263a2 face each other in a direction intersecting the advancing/retracting direction of the recording head 22 so as to be capable of abutting the pins 27a to 27c pressed against the supporting faces 261al to 263al, and thus restrict movement of the pins 27a to 27c in this intersecting direction. Further, the engaging portion of the second pin 27b and the second groove portion 262a, and the engaging portion of the third pin 27c and the third groove portion 263a are placed at positions offset in the advancing/retracting direction of the recording head 22. Accordingly, the recording head 22 is in a state of being supported by the head holder 26 in a state in which change in the angle that changes the orientation of the discharge face, i.e., relative rotation as to the head holder 26, is restricted. This supporting mode of the recording head 22 by the head holder 26 corresponds to the first mode of the present invention.

In the Present Example, the strengths of the first to third biasing members 51a to 51c are made to differ among the first recording heads 22a and the second recording heads 22b. That is to say, the biasing force of the third biasing member 51c is set to be greater than the biasing forces of the first biasing member 51a and the second biasing member 51b among the biasing members of the first recording heads 22a. Conversely, the biasing force of the first biasing member 51a is set to be greater than the biasing forces of the second biasing member 51b and the third biasing member 51c among the biasing members of the second recording heads 22b.

FIGS. 34A and 34B are schematic cross-sectional views illustrating the configuration in the biasing members 51 (first biasing member 51a, second biasing member 51b, third biasing member 51c) when the recording head 22 is positioned, in which FIG. 34A is a diagram as viewed from the apparatus rear side, and FIG. 34B is a diagram as viewed from the apparatus front side. The biasing positions of each of the biasing members when the recording head 22 abuts the positioning members 811 is in a relationship of a load being applied such that, when considering moment M about the positioning members, the abutting portions of the recording head each land on the positioning portions without fail. That is to say, in a state in which the positioned portions 221 are pressed against the positioning members 811 by the biasing force of the biasing members 51 provided to the head holder 26, the recording head 22 is balanced in a posture inclined as to the head holder 26. The recording head 22 is positioned as to the head holder 26 in this posture. Also, the first pin 27a, the second pin 27b, and the third pin 27c are a state of being released from the first groove portion 261a, the second groove portion 262a, and the third groove portion 263a. Thus, the final state of the recording head 22 is one that is completely following the positioning members 811a, 811b, and 811c, that have a predetermined difference in height, and accordingly, the recording head 22 can be positioned highly precisely in a posture inclined at a predetermined angle, at the printing position.

Note that in a case in which the recording head 22 is to be positioned at the recording position without the recording head 22 being inclined as to the advancing/retracting direction (raising/lowering direction), settings may be made in which there is no difference in biasing forces. Settings of the biasing forces change in accordance the combination with the settings of difference in height among the first and second positioning members 811a and 811b, and the third positioning member 811c, and various settings can be made. That is to say, any settings can be made as appropriate, within a range capable of stably forming a desired inclination.

Also, a biasing configuration by biasing members is not an indispensable configuration, and in a case in which the weight of the recording head 22 is sufficiently great, the biasing force of the first biasing member 51a, the second biasing member 51b, and the third biasing member 51c can be omitted. Also, although an arrangement has been made in the Present Example in which the diameter of the first pin 27a is 5.90 to 6.00 mm and the width of the first groove portion 261a is 6.00 to 6.10 mm, these are not limiting, and it is sufficient as long as the dimensional difference between the diameter of the pin and the width of the groove is up to around 1 mm. This holds true for the second pin 27b and the second groove portion 262a, and the third pin 27c and the third groove portion 263a, as well. By the first groove portion 261a, the second groove portion 262a and the third groove portion 263a provided to the head holder 26 supporting the first pin 27a, the second pin 27b, and the third pin 27c provided on the recording head 22, two of the three pins serve as a reference, and the remaining one serves as a rotation stopper. Accordingly, the recording head 22 in the retracted position is supported by the head holder 26 in a stable posture. Also, in the Present Example, the first pin 27a and the second pin 27b are provided at substantially the same height, but may be provided with different heights.

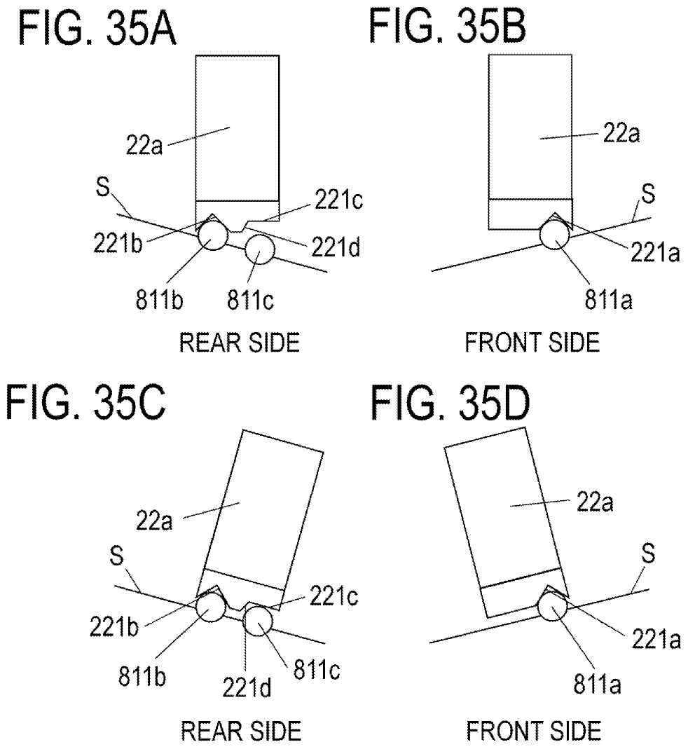

The relation between positioning of the first recording head 22a serving as the first recording head to the printing position, and the sheet S will be described with reference to FIGS. 35A to 35D. Note that here, FIGS. 35A and 35C are schematic diagrams as viewed from the apparatus rear side, and FIGS. 35B and 35D are schematic diagrams as viewed from the apparatus front side.

As illustrated in FIGS. 35A and 35B, when the first recording head 22a moves (descends) to the printing position, first, the first abutting portion 221a and the first positioning member 811a abut at the apparatus front side, and the second abutting portion 221b and the second positioning member 811b abut at the apparatus rear side. Accordingly, the upstream side portion in the sheet conveyance direction of the first recording head 22a does not descend in the downward direction any further. Thereafter, as illustrated in FIGS. 35C and 35D, the posture of the first recording head 22a is inclined, the third abutting portion 221c and the third positioning member 811c abut at the apparatus rear side, and the posture and position of the first recording head 22a as to the sheet conveying portion chassis 81 are set. That is to say, a situation in which the first recording head 22a comes into contact with the sheet S placed below the nozzle plate of the first recording head 22a will not occur.

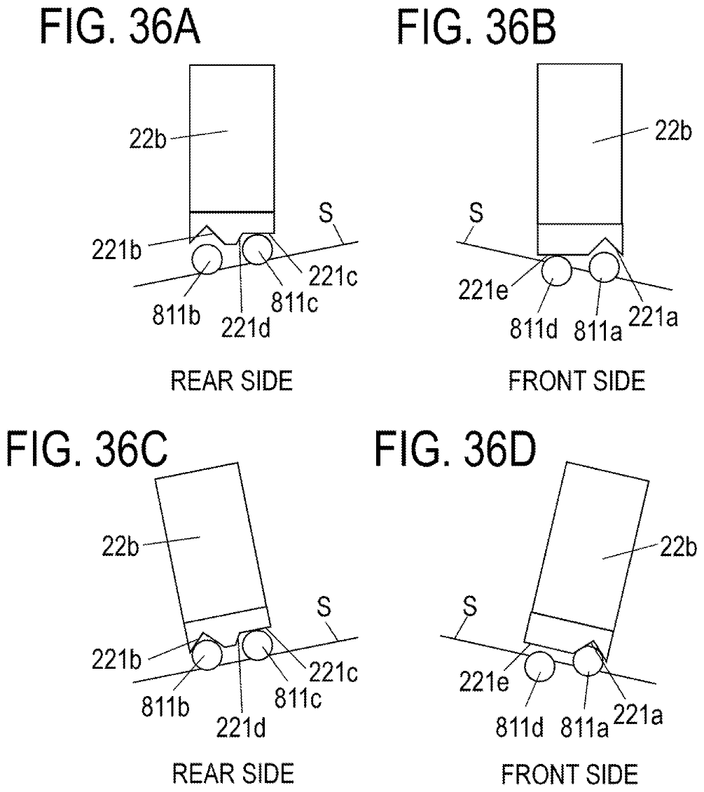

The relation between positioning of the second recording head 22b serving as the second recording head to the printing position, and the sheet S will be described with reference to FIGS. 36A to 36D. Note that here, FIGS. 36A and 36C are schematic diagrams as viewed from the apparatus rear side, and FIGS. 36B and 36D are schematic diagrams as viewed from the apparatus front side.

As illustrated in FIGS. 36A and 36B, when the second recording head 22b moves (descends) to the printing position, first, the third abutting portion 221c and the third positioning member 811c abut at the apparatus rear side, and the fourth abutting portion 221e and the restricting member 811d abut at the apparatus front side. Accordingly, the upstream side portion in the sheet conveyance direction of the second recording head 22b does not descend in the downward direction any further.

Now, as illustrated in FIG. 32B and so forth, the restricting member 811d is placed such that the height thereof is lower than the third positioning member 811c. Accordingly, with regarding the timing of abutting, the fourth abutting portion 221e and the restricting member 811d abut after the third abutting portion 221c and the third positioning member 811c abut. Also, at this time, the second recording head 22b assumes a posture of being inclined such that the apparatus front side thereof is lower than the apparatus rear side in the head longitudinal direction.

Thereafter, the posture of the second recording head 22b is included as illustrated in FIGS. 35C and 36D, the second abutting portion 221b and the second positioning member 811b abut at the apparatus rear side, and the first abutting portion 221a and the first positioning member 811a abut at the apparatus front side. At this time, the second recording head 22b returns to the posture in which the apparatus front side thereof and the apparatus rear side are the same height in the head longitudinal direction, and the fourth abutting portion 221e and the restricting member 811d separate. Accordingly, and the posture and position of the second recording head 22b as to the sheet conveying portion chassis 81 are set. That is to say, a situation in which the second recording head 22b comes into contact with the sheet S that is placed below the nozzle plate of the second recording head 22b will not occur.

Now in a case in which the restricting member 811d is not provided, after the third abutting portion 221c and the third positioning member 811c first abut at the apparatus rear side, there is a possibility that the apparatus front side of the second recording head 22b would move further downward, since there is no support of the restricting member 811d. As a result, the possibility of the second recording head 22b coming into contact with the sheet S is conceivable.

That is to say, the first and second abutting portions 221a and 221b serving as a first abutting portion, and the third abutting portion 221c serving as a second abutting portion, abut the first to third positioning members 811a to 811c at different timings. In the second recording head 22b, the third abutting portion 211c abuts the third positioning member 811c, and thereafter the first and second abutting portions 221a and 211b abut the first and second positioning members 811a and 811b, and accordingly the abutting timing of the first and second abutting portions 221a and 211b and the first and second positioning members 811a and 811b is later than the abutting timing of the third abutting portion 211c and the third positioning member 811c. The first and second abutting portions 221a and 221b serving as a first abutting portion support the second recording head 22b as to the sheet conveying portion chassis 81 at both ends of the second recording head 22b in the sheet width direction that is orthogonal to the sheet conveyance direction. Conversely, the third abutting portion 221c serving as a second abutting portion supports the second recording head 22b as to the sheet conveying portion chassis 81 at one end of the second recording head 22b in the sheet width direction. That is to say, in a case of a configuration in which the restricting member 811d is not provided, the support of the second recording head 22b as to the sheet conveying portion chassis 81 by just the third abutting portion 221c serving as a second abutting portion would be single-point support at one side, and the configuration would be such that the biasing force of the biasing members 51a to 51c would be received by one point. Accordingly, the posture of the second recording head 22b would be unstable, and that state would continue until the first and second abutting portions 221a and 211b abut the first and second positioning members 811a and 811b.

The restricting member 811d restricts the second recording head 22b, of which the posture is unstable, from assuming a posture in which it would come into contact with the sheet S, by abutting the fourth abutting portion 221e provided on the other end of the second recording head 22b in the sheet width direction. That is to say, the restricting member 811d supports the second recording head 22b to maintain a posture such that the second recording head 22b does not come into contact with the sheet S, until all abutting portions 221a to 221c abut the positioning members 811a to 811c respectively and the posture of the second recording head 22b stabilizes.

When all of the first to third abutting portions 221a to 221c abut the first to third positioning members 811a to 811c respectively, i.e., when the second recording head 22b is positioned as to the sheet conveying portion chassis 81, the restricting member 811d separates from the second recording head 22b. That is to say, the restricting member 811d is configured so as not to affect the three-point support by the three abutting portions 221a to 221c.

Note that an example is described in the Present Example in which the restricting member 811d completely separates from the second recording head 22b at the time of positioning of the second recording head 22b being completed, but a configuration may be made in which the restricting member 811d maintains the state of contact with the second recording head 22b. That is to say, advantages the same as those of the Present Example can be obtained as long as the contact between the restricting member 811d and the second recording head 22b is contact of a slight level that does not affect the three-point support by the three abutting portions 221a to 221c.

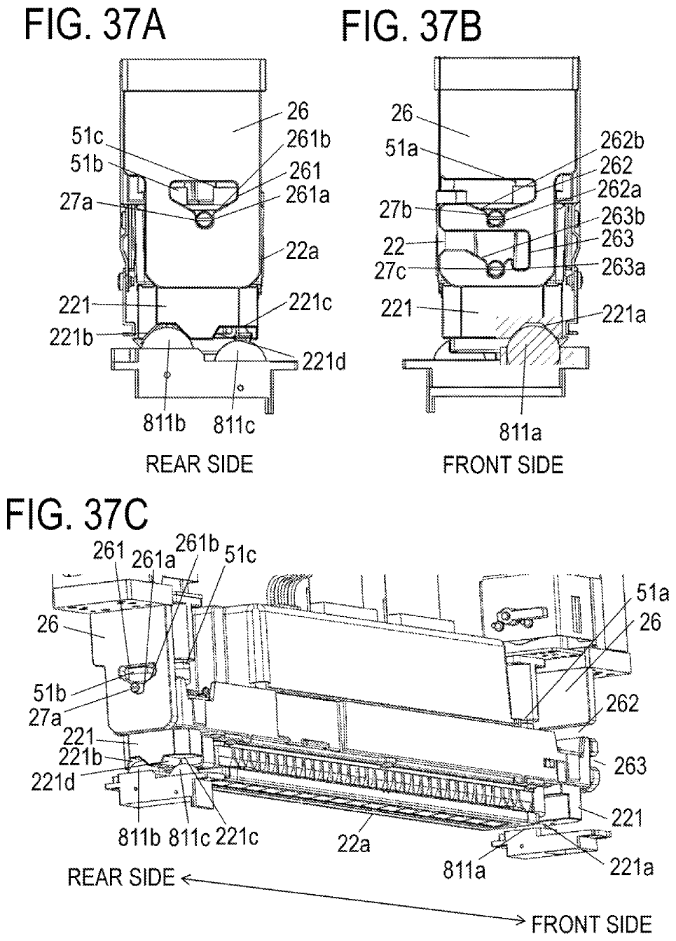

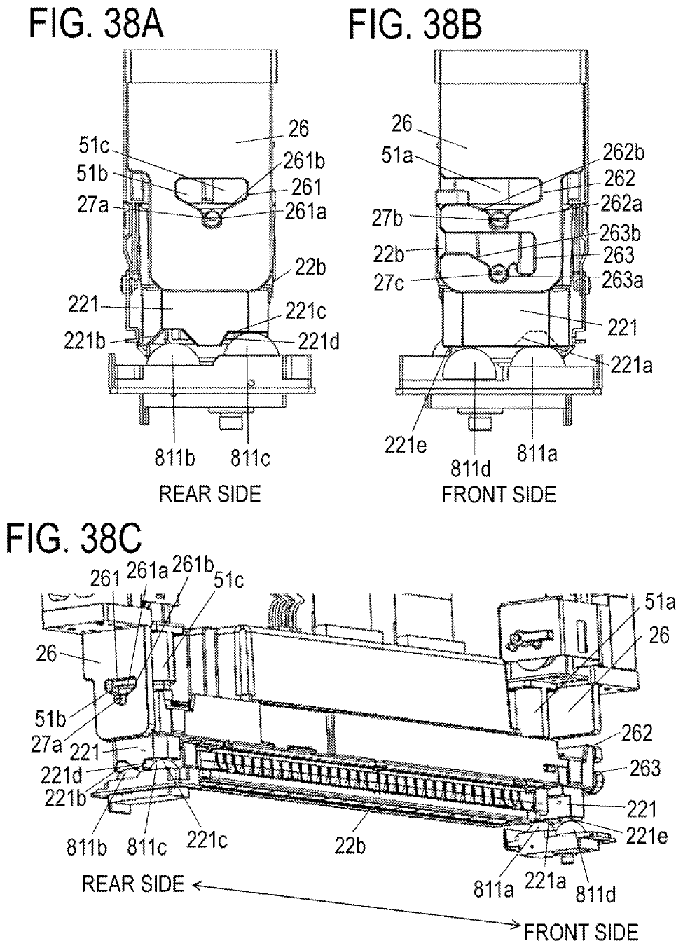

FIGS. 37A to 37C are diagrams illustrating a state in which the head holder 26 that supports the first recording head 22a descends from the retracted position toward the printing position, the first abutting portion 221a and the first positioning member 811a abut, and the second abutting portion 221b and the second positioning member 811b abut. FIGS. 38A to 38C are diagrams illustrating a state in which the head holder 26 that supports the second recording head 22b descends from the retracted position toward the printing position, the third abutting portion 221c and the third positioning member 811c abut, and the fourth abutting portion 221e and the restricting member 811d abut. FIGS. 37A and 38A are schematic views as viewed from the apparatus rear side, FIGS. 37B and 38B are schematic views as viewed from the apparatus front side, and FIGS. 37C and 38C are perspective views as viewed from the downstream side in the sheet conveyance direction.

At the time of descending from the retracted position to the printing position, the first pin 27a, the second pin 27b, and the third pin 27c of the recording head 22 maintain the state of being respectively supported by the first groove portion 261a, the second groove portion 262a, and the third groove portion 263a, of the head holder 26. That is to say, the recording head 22 is supported by the head holder 26 in the first supporting mode, in which the change in angle that changes the orientation of the discharge face is restricted.

Now, the plurality of positioning members 811 of the sheet conveying portion chassis 81 are in an arc-like array configuration in the Present Example, and accordingly each of the plurality of recording heads 22 needs to be moved to different heights from each other when descending from the retracted position toward the printing position. Accordingly, position detection of the plurality of recording heads 22 is performed by a position detection sensor (omitted from illustration) provided partway along the way of descending from the retracted position to the printing position, and the plurality of recording heads 22 are each imparted a different additional descent amount from the place of position detection. In order to impart different descent amounts, changing the amount of driving of the motors driven at the time of descent enables the plurality of recording heads 22 to be moved (lowered) to different heights from each other at the printing position. In the Present Example, the plurality of recording heads 22 are imparted a predetermined angle, and changing the driving amount of the motors when giving this angle as well enables inclining at predetermined angles.

As illustrated in FIGS. 38A and 38B, at the second recording head 22b, the fourth abutting portion 221e and the restricting member 811d abut at the apparatus front side, and the third abutting portion 221c and the third positioning member 811c abut at the apparatus rear side. Thus, the upstream portion of the second recording head 22b in the sheet conveyance direction does not descend downward any further. Accordingly, the second recording head 22b can be prevented from coming into contact with the sheet S placed below the nozzle plate of the second recording head 22b.

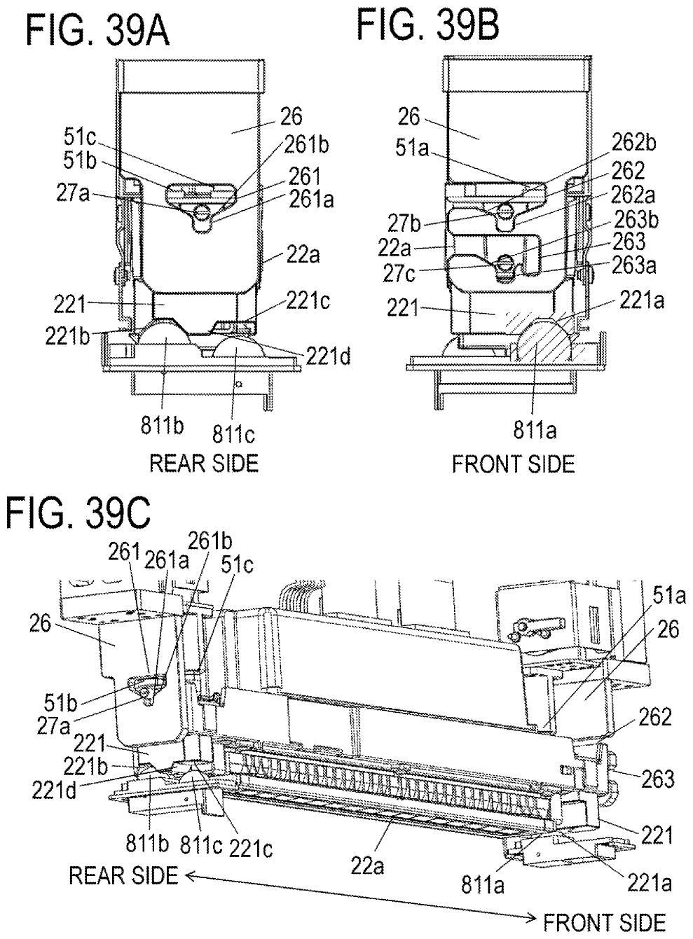

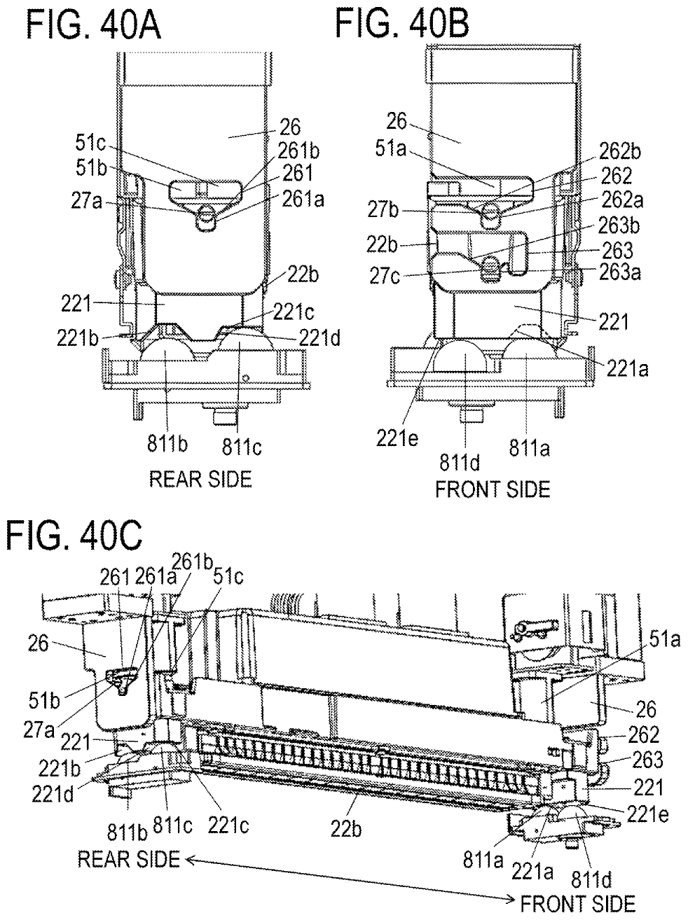

FIGS. 39A to 39C and 40A to 40C are diagrams illustrating states of the head holder 26 further descending toward the printing position from the state in FIGS. 37A to 37C and 38A to 38C. FIGS. 39A and 40A are schematic views as viewed from the apparatus rear side, FIGS. 39B and 40B are schematic views as viewed from the apparatus front side, and FIGS. 39C and 40C are perspective views as viewed from the downstream side in the sheet conveyance direction.

FIGS. 39A to 39C and 40A to 40C illustrate the way in which the recording head 22 moves relative to the head holder 26, in the direction opposite to the descending direction, due to force acting against the biasing force of the biasing members 51a to 51c being generated at part of the abutting portions abutting the positioning members. The biasing force of the biasing members 51a to 51c acts in a first direction in which the recording head 22 heads from the retracted position toward the printing position with respect to the head holder 26. The recording head 22 is subjected to force acting in a direction against the biasing force from the first positioning member 811a at the first abutting portion 221a, and similarly is subjected to force acting in a direction against the biasing force from the third positioning member 811c at the third abutting portion 221c. Due to this reactive force acting, the pins 27a to 27c are guided by the groove side faces (restricting faces) of the respective groove portions 261a to 263a, and the recording head 22 moves relative to the head holder 26, in the second direction opposite to the first direction. As a result, the first pin 27a, the second pin 27b, and the third pin 27c of the recording head 22 are each separated from the supporting faces 261al to 263al of the first to third groove portions 261a to 263a of the head holder 26, as illustrated in FIGS. 39A to 39C and 40A to 40C.

During the descent of the head holder 26 from the state illustrated in FIGS. 37A to 37C and 38A to 38C to the state illustrated in FIGS. 39A to 39C and 40A to 40C, the first to third pins 27a to 27c of the recording head 22 are maintained in the state of being clamped by the respective restricting faces 261a2 to 263a2. That is to say, the first to third pins 27a to 27c of the recording head 22 function as positioning or rotation stopping members regarding the sheet conveyance direction, as to the first to third groove portions 261a to 263a of the head holder 26. Accordingly, the recording head 22 maintains a substantially parallel state.

When completing transition from the state illustrated in FIGS. 37A to 37C and 38A to 38C to the state illustrated in FIGS. 39A to 39C and 40A to 40C, the pins 27a to 27c are completely disengaged from the groove portions 261a to 263a, and move to the opened portions 261d to 263d in which the movable range thereof in the holes 261 to 263 is broadened. In this state, the pins 27a to 27c are capable of relative movement over a wide range as to the holes 261 to 263, and the recording head 22 is supported by the head holder 26 in a state capable of movement that is relative to the head holder 26, by which the angle of the discharge orifice face can be changed. This supporting mode corresponds to the second mode of the present invention.

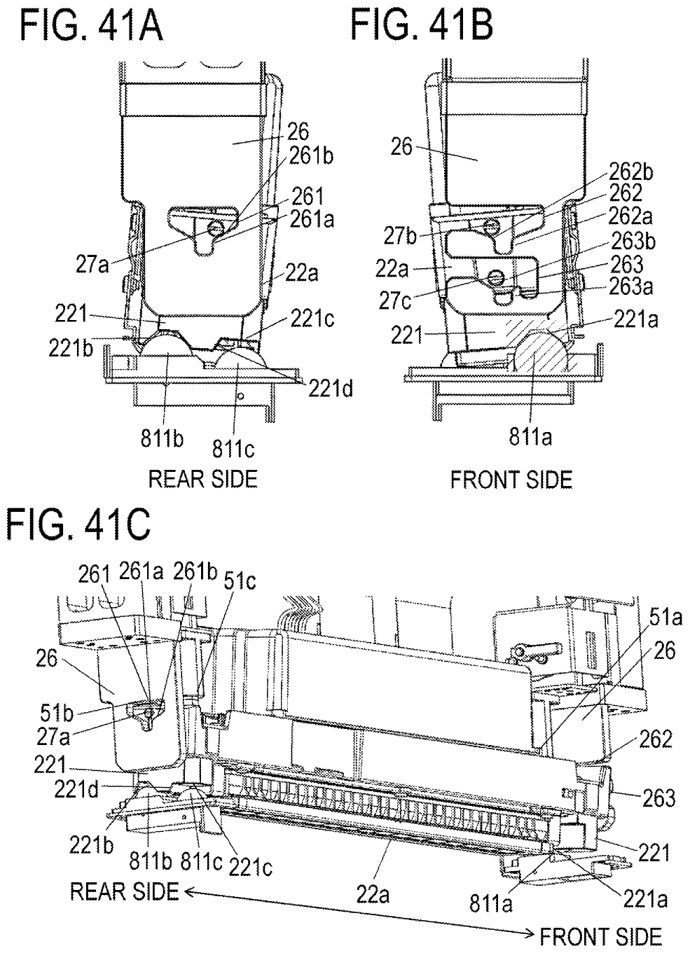

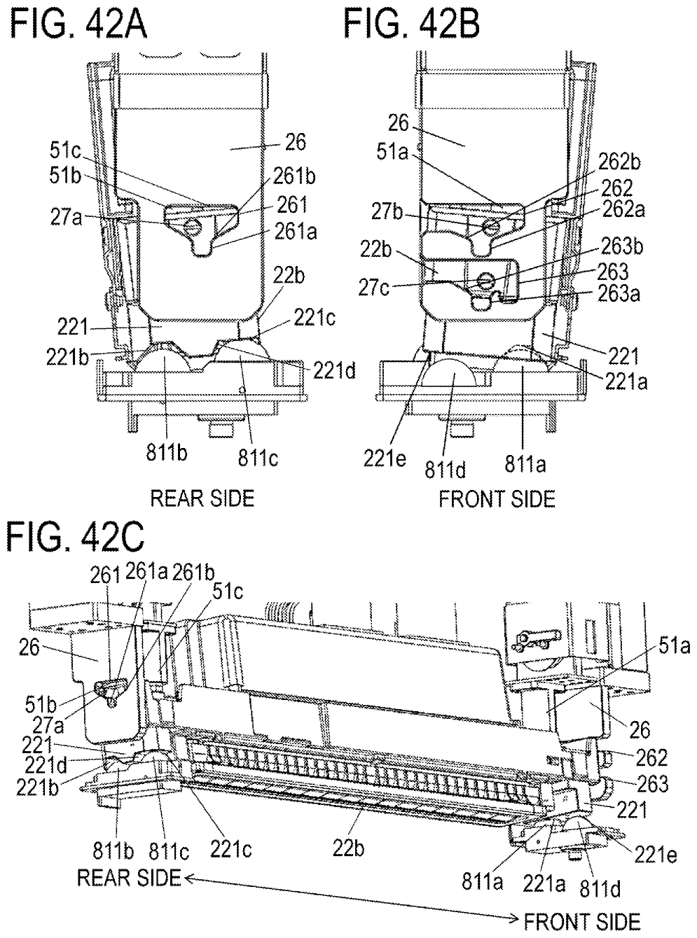

FIGS. 41A to 41C and 42A to 42C are diagrams illustrating states of the head holder 26 further descending toward the printing position from the state in FIGS. 39A to 39C and 40A to 40C. FIGS. 41A and 42A are schematic views as viewed from the apparatus rear side, FIGS. 41B and 42B are schematic views as viewed from the apparatus front side, and FIGS. 41C and 42C are perspective views as viewed from the downstream side in the sheet conveyance direction.

As illustrated in FIGS. 39A to 39C and 40A to 40C, the pins 27a, 27b, and 27c of the recording head 22 are each separated from the groove portions 261a, 262a, and 263a of the head holder 26, and are in a state in which the movable ranges thereof as to the hole 261, the hole 262, and the hole 263, are broadened. Accordingly, the recording head 22 is capable of change in posture in which the angle of the discharge orifice face is changed, due to balance in force acting on the abutting portions from the positioning members, biasing force from the biasing members acting on the plate 52, and so forth, at the time of the recording head 22 further descending toward the printing position in the head holder 26.

Specifically, the first recording head 22a illustrated in FIGS. 39A to 39C is capable of rotating as to the head holder 26, about a straight line passing through the center of the first positioning member 811a and the center of the second positioning member 811b serving as a rotational axis line. Now, in the biasing members of the first recording head 22a, the biasing force of the third biasing member 51c is set to be greater than the biasing forces of the first biasing member 51a and the second biasing member 51b. Accordingly, the first to third pins 27a to 27c are each further separated from the first to third groove portions 261a to 263a as force acts to rotate the recording head 22 in the direction in which the third abutting portion 221c and the third positioning member 811c abut.

Meanwhile, the second recording head 22b illustrated in FIGS. 40A to 40C is capable of rotating as to the head holder 26, about a straight line that is parallel to the straight line passing through the center of the first positioning member 811a and the center of the second positioning member 811b and that passes through the center of the third positioning member 811c serving as a rotational axis line. This rotation is realized by the fourth abutting portion 221e abutting the restricting member 811d at the opposite side from the third abutting portion 221c in the sheet width direction. Now, in the biasing members of the second recording head 22b, the biasing force of the first biasing member 51a is set to be greater than the biasing force the third biasing member 51c. Accordingly, the first to third pins 27a to 27c are each further separated from the first to third groove portions 261a to 263a as force acts to rotate the recording head 22 in the direction in which the first and second abutting portions 221a and 221b and the first and second positioning members 811a and 811b abut.

Now, in the Present Example, the guide form portion 221d is provided near the third abutting portion 221c that is made up of a planar portion. At the time of the second recording head 22b rotating about the straight line that is parallel to the straight line passing through the center of each of the first and second positioning members 811a and 811b and that passes through the center of the third positioning member 811c serving as a rotational axis line, misalignment can occur due to slipping occurring at the third abutting portion 221c that is made up of a planar portion. The guide form portion 221d continues the third abutting portion 221c in a manner inclined thereto, and is configured to restrict the third positioning member 811c from being disengaged due to slipping at the third abutting portion 221c. Even in a case in which slipping of the third abutting portion 221c as to the third positioning member 811c occurs at the time of the second recording head 22b being rotated with the third abutting portion 221c and the third positioning member 811c abutted, positioning of the second recording head 22b can be performed in a sure manner due to the guide form portion 221d. That is to say, the guide form portion 221d suppresses a situation from occurring in which the abutting portions 221a to 221c do not fit to the positioning members 811a to 811c due to misalignment of the recording head 22b, and positioning cannot be performed.

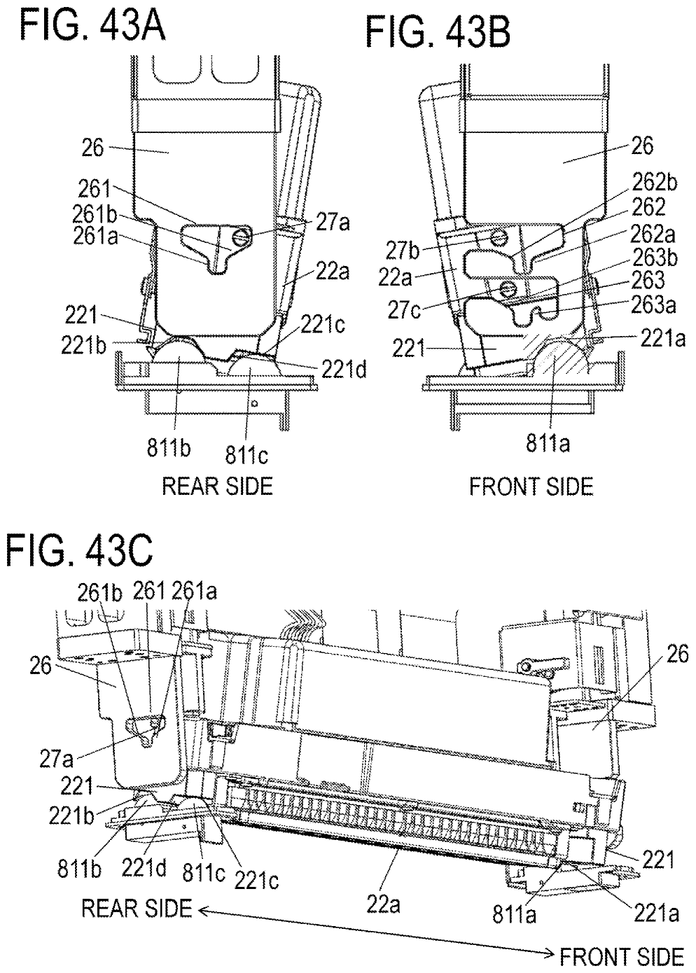

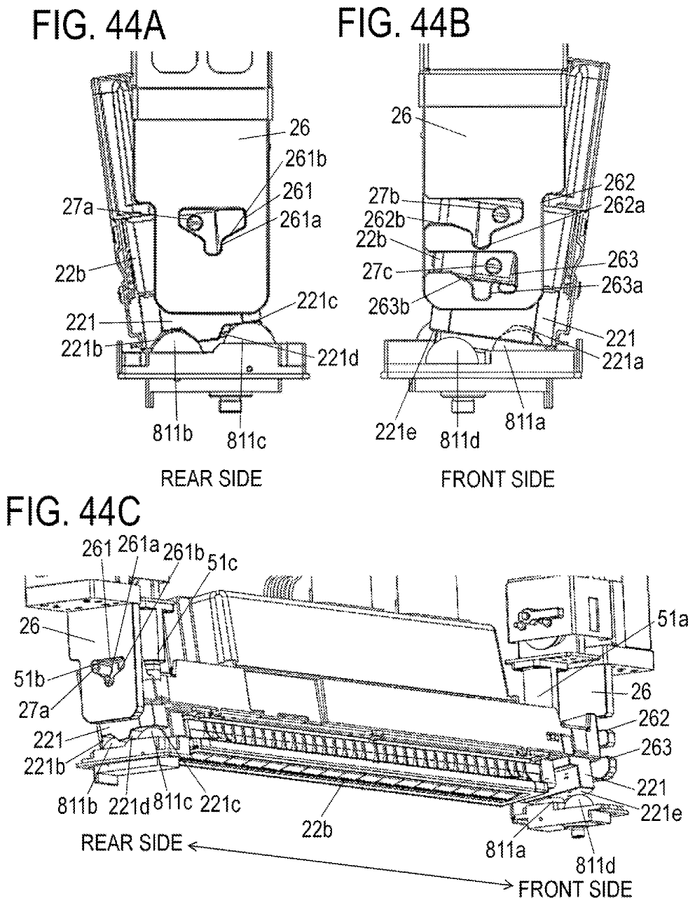

FIGS. 43A to 43C and 44A to 44C are diagrams illustrating a state in which positioning of the recording head 22 as to the positioning supporting portions 810 of the sheet conveying portion chassis 81 is complete (printing position). FIGS. 43A and 44A are schematic views as viewed from the apparatus rear side, FIGS. 43B and 44B are schematic views as viewed from the apparatus front side, and FIGS. 43C and 44C are perspective views as viewed from the downstream side in the sheet conveyance direction.

The first recording head 22a continues to rotate about the rotational axis line due to the head holder 26 further descending from the state illustrated in FIGS. 41A to 41C, and the third abutting portion 221c and the third positioning member 811c abut. Meanwhile, the second recording head 22b continues to rotate about the rotational axis line due to the head holder 26 further descending from the state illustrated in FIGS. 42A to 42C, and the first abutting portion 221a and second abutting portion 221b, and the first positioning member 811a and second positioning member 811b abut.

Now, the sliding portions 512a, 512b, and 512c are configured to be capable of sliding such that the positions of contact as to the plate 52 change, while changing the amounts of protrusion from the base portions 511a, 511b, and 511c. Accordingly, the biasing members 51a, 51b, and 51c can bias the recording head 22 against the positioning members 811 while each following the movement of the plate 52 accompanying change in the angle of the recording head 22.

Also, the first pin 27a, the second pin 27b, and the third pin 27c are in a state of being released from the first groove portion 261a, the second groove portion 262a, and the third groove portion 263a, respectively.

Further, as illustrated in FIG. 44B, the fourth abutting portion 221e and the restricting member 811d are in a separated state. Accordingly, the recording head 22 is in a state of completely following the first positioning member 811a, the second positioning member 811b, and the third positioning member 811c, finally placed at the predetermined angle, and accordingly positioning at the printing position can be performed with high precision. Note, however, that depending on the positioning angle of the recording head 22 at the printing position, the biasing force of the first biasing member 51a, the second biasing member 51b, and the third biasing member 51c is not necessarily indispensable, and a configuration may be made in which positioning is performed by being biased by the weight of the recording head 22 itself.

Support Configuration of Recording Heads and Positioning at Maintenance Position Operations of the support configuration when performing positioning as to the maintenance position are the same as when performing positioning as to the printing position, except that no inclining movement of the posture of the recording head 22 occurs, and accordingly description will be omitted.

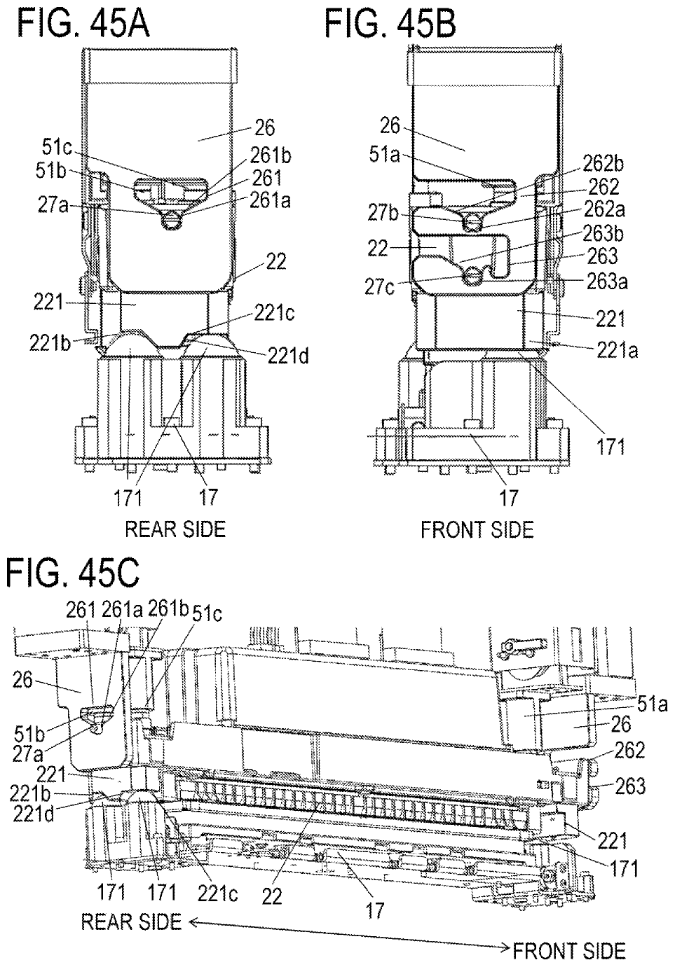

FIGS. 45A to 45C are schematic diagrams illustrating a state in which positioning of the recording head 22 and the maintenance portion 17 is completed (maintenance position). FIG. 45A is a schematic diagram as viewed from the apparatus rear side, FIG. 45B is a schematic diagram as viewed from the apparatus front side, and FIG. 45C is a perspective diagram as viewed from the downstream side in the sheet conveyance direction.

Now, in the Present Example, the maintenance portion 17 is configured with a plurality of recording head positioning portions 171 placed in a substantially straight line. Accordingly, the first abutting portion 221a and the first positioning member 811a, the second abutting portion 221b and the second positioning member 811b, and the third abutting portion 221c and the third positioning member 811c, abut respectively at almost the same time. At the maintenance position, the plurality of recording heads 22 are placed so as to be arrayed at the same height as each other, and there is no need to move to different heights as when at the printing position. Accordingly, when lowering the plurality of recording heads 22 to the maintenance position, the amount of descent from the detection position of detection by the position detection sensor (omitted from illustration) of the apparatus main unit is made to be the same amount of descent by unifying the motor driving amount among the plurality of recording heads 22, and positioning operations of the recording heads 22 are thus performed.

According to the Present Example, a plurality of recording heads can be positioned at optional placements with high precision. Specifically, the recording heads can be position with high precision at the printing position in which the plurality of recording heads are to be arrayed at different heights from each other in accordance with the sheet conveyance path, and at the maintenance position in which the recording heads are to be arrayed at the same height as each other. That is to say, the maintenance unit does no need to be formed to match the placement of the recording heads, and the placement of the recording heads can be made to match the form of the maintenance unit. Accordingly, the maintenance unit can be configured to be suitable for apparatus space conservation, and the size of the apparatus can be reduced.

According to the Present Example, a guide mechanism, with a high level of general-use versatility can be realized, in which the recording head 22 can be positioned at an optional angle. That is to say, movement of the head holder 26 that supports the recording head 22 is a simple moving configuration of which the movement direction thereof is only in a linear direction. By the recording head 22 abutting the positioning members 811, the supporting mode of the recording head 22 by the head holder 26 changes from the first mode in which rotation of the recording head 22 is restricted to the second mode in which rotation thereof is permitted. This configuration is realized by refining the engagement configuration of the pins 27 of the recording head 22 and the holes 261 to 263 of the head holder 26. That is to say, the holes 261 to 263 are configured having the groove portions 261a to 263a that restrict movement of the pins 27 in the lateral direction that intersects the movement direction of the head holder 26, and the opened portions 261d to 263d that permit lateral-direction movement of the pins 27 within a predetermined range. The change in the supporting mode described above is enabled by the configuration in which the engagement positions of the pins 27 as to the holes 261 to 263 change by the recording head 22 moving relative to the head holder 26 due to abutting the positioning members 811.

According to the Present Example, the magnitude of inclination of the recording head when being positioned at the recording position can be appropriately set by providing a difference in timing of abutting among each of the plurality of abutting portions and the corresponding plurality of positioning portions. Specifically, this refers to the difference between the first abutting timing of the first abutting portion (abutting portions 221a and 221b) and the first positioning portions (positioning members 811a and 811b) and the second abutting timing of the second abutting portion (abutting portion 221c) and the second positioning portion (positioning member 811c). By appropriately setting this difference in timing in accordance with the desired positioning angle of the recording head, the recording head can be made to incline at the desired angle.

In the Present example, a configuration is described in which the above abutting timing difference is created by providing a difference between the first abutting position at which the first abutting portion and the first positioning portion abut, and the second abutting position at which the second abutting portion and the second positioning portion abut, in the raising/lowering direction of the recording head. More specifically, in the Present Example, the difference in the abutting positions is made to occur by creating a difference in height between the first positioning portion and the second positioning portion, in the raising/lowering direction of the recording head.

Now, the configuration for creating the difference in the abutting timing is not limited to the configuration illustrated in the Present Example. For example, a configuration may be made in which there is no difference created in height between the first positioning portion and the second positioning portion, and instead a difference is created in height between the first abutting portion and the second abutting portion, in the raising/lowering direction, so that the difference in abutting timing occurs. Alternatively, a configuration may be made in which a difference is created in height between the first positioning portion and the second positioning portion, and a difference is also created in height between the first abutting portion and the second abutting portion.

In the Present Example, a configuration is described in which the posture of a recording head is restricted by a restricting portion in a case in which the posture of the recording head becomes unstable due to the time difference in abutting timings. Accordingly, when performing positioning at the printing position, a situation can be avoided in which the positionally-unstable recording head comes into contact with the sheet. Further, a configuration is made such that at the time of all abutting portions abutting and being positioned, the restricting portion is separated from the recording head. Thus, a situation in which the posture restriction of the recording head by the restricting portion affects the precision of positioning by the abutting portions can be avoided.

Also, a configuration is described in the Present Example in which spheres of the same diameter are used for the positioning members 811a to 811c and the restricting member 811d, which are fit into the recessed portions 812 of the positioning supporting portions 810, thereby forming the positioning portions. According to this configuration, creating the difference in height among a plurality of the recessed portions 812 enables the configuration of creating the difference in abutting timings described above to be easily realized. That is to say, all that is necessary is to vary the forms of the recessed portions 812 of the positioning supporting portions 810 in accordance with the specifications of the individual recording heads 22, and other member configurations can be used in common, thus enabling a guide mechanism with a high level of general-use versatility to be realized.

Note however, that the configurations of the positioning portions and the restricting portion are not limited to the configuration of the Present Example. For example, a configuration may be made in which no difference is created in height among the plurality of recessed portions 812, and the difference in abutting timing is created by varying the shapes and sizes of the positioning members and the restricting member. Also, the shapes of the positioning members and the restricting member are not limited to spheres, and may be a form having partial spherical faces at least on regions abutting the abutting portions, for example. Also, a configuration may be made in which the positioning members 811a to 811c and the restricting member 811d, and the positioning supporting portions 810 are formed integrally.

Also, although a configuration has been described in the Present Example regarding the positioning abutting configuration in which the abutting portions are recessed forms and the positioning portions are protruding forms, and positioning is performed by fitting the recesses and the protrusions thereof, this configuration is not limiting. For example, the abutting portions may be protruding forms and the positioning portions may be recessed forms, or a combination may be made in which part of the plurality of abutting portions are recessed forms and the rest are protruding forms, and correspondingly, part of the positioning portions are protruding forms and the rest are recessed forms.

Also, the specific forms of the recessed forms of the abutting portions, i.e., the combination of placement of cones and grooves may be in a layout that is different from that in the Present Example. In the Present Example, the abutting portion 221b serving as a first abutting portion that is provided on the same side as the abutting portion 221c serving as a second abutting portion in the sheet width direction (recording head longitudinal direction) is a groove form portion, and the abutting portion 221a serving as a first abutting portion that is provided on the opposite side is a recessed conical portion. Conversely, for example, the abutting portion 221a may be changed from a recessed conical portion to a groove form portion, and the abutting portion 221b may be changed from a groove form portion to a recessed conical portion.

Note that in the Present Example, a configuration is made in which the side on which the abutting portion 221a having a conical form is provided is a reference point side at the time of recording operations by the recording head 22, and the side on which this conical portion is provided and a conveyance reference side for sheets in the sheet width direction are on the same side. That is to say, a configuration is made in which the positioning configuration to serve as the operation reference point side of the recording head 22 is an engaging configuration of the abutting portion 221a that is a conical recessed portion, and the positioning member 811a that is a partially spherical protruding portion, thereby restricting the position of each other in the sheet conveyance direction and the sheet width direction. Conversely, the positioning configuration on the opposite side from the operation reference side of the recording head 22 is the abutting portions 221b and 221c that are groove forms opened in the sheet width direction, thereby forming a configuration in which the effects of dimensional error and so forth are accommodated (dimensional error is taken up). Thus, having the reference point for the recording head 22 and the sheet conveyance reference on the same side is preferable from the perspective of image quality in recorded images, and variance in image positions of images formed on the sheet can be reduced. Also, distancing the conical portion that serves as the reference point for the recording head 22 as far away from apparatus heat sources as possible yields a configuration in which effects of thermal deformation are not readily manifested. In the Present Example, a configuration is made in which the position for providing the conical portion is not on the apparatus rear side where there are many heat sources, such as electrical boards and so forth, but on the apparatus front side.

Also, although the abutting portion 221c serving as a second abutting portion is placed on the same side (apparatus rear side) as the abutting portion 221b in the longitudinal direction (width direction) of the recording head 22 in the Present Example, placement thereof may be on the same side (apparatus front side) as the abutting portion 221a on the opposite side.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2022-109914, filed on Jul. 7, 2022, and No. 2022-122717, filed on Aug. 1, 2022, which are hereby incorporated by reference herein in their entirety.

What is claimed is:

1. A recording apparatus, comprising:
a conveying roller configured to convey a recording medium in a conveyance direction; and
a moving portion configured to move a recording head between a positioning position and a non-positioning position, the moving portion having a first supporting portion that supports the recording head at the non-positioning position, wherein
the first supporting portion does not support the recording head at the positioning position.

2. The recording apparatus according to claim 1, wherein
the first supporting portion supports one end of the recording head in an intersecting direction that intersects the conveyance direction.

3. The recording apparatus according to claim 2, wherein
the moving portion has a second supporting portion that supports the other end of the recording head at the non-positioning position in the intersecting direction.

4. The recording apparatus according to claim 1, wherein
the moving portion has a rotation restricting portion that restricts rotation of the recording head at the non-positioning position about an axis extending in an intersecting direction that intersects the conveyance direction.

5. The recording apparatus according to claim 1, wherein
the first supporting portion includes
a first supporting face that comes into contact with a first supported portion of the recording head in a state of being at the non-positioning position, and that does not come into contact with the first supported portion in a state of the recording head being at the positioning position, and
a first restricting face that is capable of abutting the first supported portion that is in contact with the first supporting face, in a second intersecting direction that intersects each of a moving direction of the moving portion and the intersecting direction.

6. The recording apparatus according to claim 5, wherein
the first supported portion protrudes in the intersecting direction from one end of the recording head in the intersecting direction.

7. The recording apparatus according to claim 3, wherein
the second supporting portion includes
a second supporting face that comes into contact with a second supported portion of the recording head in a state of being at the non-positioning position, and that does not come into contact with the second supported portion in a state of the recording head being at the positioning position, and
a second restricting face that is capable of abutting the second supported portion that is in contact with the second supporting face, in a second intersecting direction that intersects each of a moving direction of the moving portion and the intersecting direction.

8. The recording apparatus according to claim 4, wherein
the rotation restricting portion has an abutting face that is capable of abutting the recording head in a second intersecting direction that intersects each of a moving direction of the moving portion and the intersecting direction, in a state in which the recording head is at the non-positioning position.

9. The recording apparatus according to claim 1, wherein
the positioning position is a recording position at which the recording head performs recording by discharging a liquid to the recording medium.

10. The recording apparatus according to claim 1, wherein
the positioning position is a maintenance position at which maintenance of the recording head is performed.

11. A recording apparatus, comprising:
a recording unit including a first recording head and a second recording head; and
a moving portion configured to support the recording unit, and configured to move the recording unit to a first position and a second position, wherein
the first recording head is positioned in a first relative placement with respect to the second recording head in a state in which the recording unit is at the first position, and is positioned in a second relative placement that is different from the first relative placement with respect to the second recording head in a state in which the recording unit is at the second position.

12. The recording apparatus according to claim 11, further comprising:
a conveyance unit, placing the recording unit at the first position, configured to convey a recording medium on which the recording unit records; and
a maintenance unit, placing the recording unit at the second position, configured to perform maintenance of the recording unit.

13. The recording apparatus according to claim 11, wherein
the first recording head and the second recording head
are arrayed at different heights from each other in the first relative placement, and
are arrayed at the same height as each other in the second relative placement.

14. The recording apparatus according to claim 11, wherein
in the first relative placement, a first angle of a discharge face of the first recording head with respect to a horizontal direction differs from a second angle of a discharge face of the second recording head with respect to the horizontal direction, and
in the second relative placement, the first angle and the second angle are the same.

15. The recording apparatus according to claim 11, wherein
the moving portion supports the first recording head and the second recording head in a state in which the recording unit is not at the first position and a state in which the recording unit is not at the second position, and does not support the first recording head and the second recording head in the state in which the recording unit is at the first position and the state in which the recording unit is at the second position.

16. The recording apparatus according to claim 11, further comprising:
a conveyance unit configured to convey a recording medium that the recording unit records on in a conveyance direction, wherein
the second recording head is placed upstream of the first recording head in the conveyance direction, and
a restricting portion is provided upstream of a first abutting portion in the conveyance direction, which is the other end of the second recording head in a width direction of the recording medium orthogonal to the conveyance direction.

17. A recording apparatus, comprising:
a recording head having a first abutting portion and a second abutting portion;
a moving portion configured to move the recording head between a positioning position and a non-positioning position; and
a positioning portion which the first abutting portion and the second abutting portion abut in a state in which the recording head is at the positioning position, wherein
in a case of the recording head moving from the non-positioning position to the positioning position, the second abutting portion abuts the positioning portion, and thereafter the first abutting portion abuts the positioning portion.

18. The recording apparatus according to claim 17, further comprising:
a restricting portion configured to restrict a posture of the recording head from the second abutting portion abutting the positioning portion until the first abutting portion abuts the positioning portion.

19. The recording apparatus according to claim 18, wherein
the restricting portion abuts the recording head prior to the first abutting portion abutting the positioning portion, and is separated from the recording head following the first abutting portion abutting the positioning portion.
